(19) United States
(12) Patent Application Publication
(10) Pub. No.: US 2014/0236820 A1
(43) Pub. Date: Aug. 21, 2014

(54) SYSTEMS AND METHODS OF REMOTE PAYMENT FOR STORED VALUE SETTLEMENT

(71) Applicant: Certegy Check Services, Inc., Tampa, FL (US)

(72) Inventors: Thomas CARLTON, Tampa, FL (US); Aaron CALIPARI, Clearwater, FL (US); Karen EAGLE, Lutz, FL (US)

(73) Assignee: Certegy Check Services, Inc., Tampa, FL (US)

(21) Appl. No.: 13/772,220

(22) Filed: Feb. 20, 2013

(51) Int. Cl. G06Q 20/10

(52) U.S. Cl. CPC G06Q 20/108
USPC 705/42

(57) ABSTRACT

Methods and systems for depositing a check using a mobile device are disclosed. Methods may include, for example, receiving, from a mobile device, a deposit request and check image, performing an image quality analysis and a check decision authorization process using the request, determining whether the deposit would exceed one or more limits, and if not, determining a type of processing for the deposit. If a warranty processing system is used, the method may include creating and sending an image file associated with the check to a bank associated with the check decision provider, and sending an approval response to a bank associated with the account issuer; and if self-risk processing is used, the method may include creating and sending an image file associated with the check to a bank associated with the account issuer. Similarly, disclosed systems may include memory containing instructions configured to operate such methods.

### DESCRIPTION OF THE DISCLOSURE

The present disclosure relates to methods and systems for depositing checks and other instruments using images of those checks. Some methods and systems comprise settlement, deposit, funding, and return management methods and systems. The present disclosure also relates to methods and systems for consumers to enroll in systems implementing these systems and methods, enabling consumers to utilize them.

### SUMMARY OF DISCLOSED EMBODIMENTS

The present disclosure includes exemplary methods and systems. In one embodiment, an exemplary method may include steps of receiving, from a mobile device associated with an account holder, a deposit request for a check, comprising an account identifier and a check image. The method may further comprise performing an image quality analysis and a check decision authorization process, and determining whether the deposit request exceeds at least one limit. If the deposit request does not exceed at least one limit, the method may determine whether the image quality analysis and check decision authorization process were successful, and if so, determining whether the account issuer uses warranty processing or self-risk processing. If the account issuer uses warranty processing, the method may be operable to create and send an image file associated with the check to a bank associated with the check decision provider, and send an approval response to a bank associated with the account issuer. If, on the other hand, the account issuer uses self-risk processing, the method may be operable to create and send an image file associated with the check to a bank associated with the account issuer.

In another embodiment, an exemplary method for processing a check deposit request may include steps of receiving a deposit request for a check, from a mobile device associated with a consumer, the deposit request comprising an account identifier and a check image. The method may further comprise determining whether the deposit request exceeds at least one limit, and based on the determining step, sending the deposit request to a computer associated with a check decision provider. The method may further comprise receiving a response from the computer associated with the check decision provider, wherein if the response comprises a denial, sending a message to the mobile device indicating that the deposit request associated with the check image can be attempted again.

In another embodiment, an exemplary system may include at least one processor and a memory containing instructions. The instructions may be configured to, when executed by the at least one processor, cause the at least one processor to perform a method. The method may comprise steps of receiving, from a mobile device associated with an account holder, a deposit request for a check, comprising an account identifier and a check image. The method may further comprise performing an image quality analysis and a check decision authorization process, and determining whether the deposit request exceeds at least one limit. If the deposit request does not exceed at least one limit, the method may determine whether the image quality analysis and check decision authorization process were successful, and if so, determining whether the account issuer uses warranty processing or self-risk processing. If the account issuer uses warranty processing, the method may be operable to create and send an image file associated with the check to a bank associated with the check decision provider, and send an approval response to a bank associated with the account issuer. If, on the other hand, the account issuer uses self-risk processing, the method may be operable to create and send an image file associated with the check to a bank associated with the account issuer.

In another embodiment, an exemplary system may include at least one processor and a memory containing instructions. The instructions may be configured to, when executed by the at least one processor, cause the at least one processor to perform a method. The method may comprise steps of receiving a deposit request for a check, from a mobile device associated with a consumer, the deposit request comprising an account identifier and a check image. The method may further comprise determining whether the deposit request exceeds at least one limit, and based on the determining step, sending the deposit request to a computer associated with a check decision provider. The method may further comprise receiving a response from the computer associated with the check decision provider, wherein if the response comprises a denial, sending a message to the mobile device indicating that the deposit request associated with the check image can be attempted again.

Some embodiments enable the deposit of paper checks using mobile devices. The present disclosure also related to exemplary systems for enrolling mobile devices to utilize the disclosed systems and methods of depositing checks using mobile devices.

In some embodiments, checks may be deposited to accounts linked to prepaid payment card accounts. While some embodiments in this disclosure relate to depositing a check into a prepaid card account, one of ordinary skill will understand that other uses and variants are possible as well. For example, disclosed embodiments can be used for bill payment, person-to-person payment, or the like.

### BRIEF DESCRIPTION OF THE DRAWINGS

FIG. 1 shows an exemplary check 100 and mobile device 201, consistent with embodiments of the present disclosure.

FIG. 2 shows an exemplary network layout, consistent with disclosed embodiments.

FIG. 3 shows an exemplary process for enrolling a consumer, consistent with the disclosed embodiments.

FIG. 4 shows an exemplary process for initiating a check deposit consistent with the disclosed embodiments.

FIGS. 5A, 5B, 5C, and 5D show portions comprising an exemplary deposit process, consistent with the disclosed embodiments.

FIG. 6 shows an exemplary check decision authorization process and optional manual review process, consistent with disclosed embodiments.

FIG. 7 shows an exemplary settlement flow diagram consistent with the disclosed embodiments.

FIGS. 8A and 8B show an exemplary funding and return management flow, consistent with the disclosed embodiments.

FIG. 9 shows an exemplary computing device 900, consistent with disclosed embodiments,

### DESCRIPTION OF THE EMBODIMENTS

Reference will now be made in detail to some exemplary embodiments of the invention, examples of which are illustrated in the accompanying drawings.

Check deposits may involve risk. For example, a consumer may attempt to deposit a void check, a check that will bounce, a check that is invalid, or the like. If the bad check is nonetheless deposited to the consumer's account, then disclosed embodiments may begin a process of check recovery. Disclosed embodiments include features which are usable to mitigate, assign, and adjust that risk. Various types of funding options (e.g. an “instant” or “delayed”) and settlement services (e.g. “warranty” or “self-risk”) enable the mitigation, assignment, and adjustment of risk.

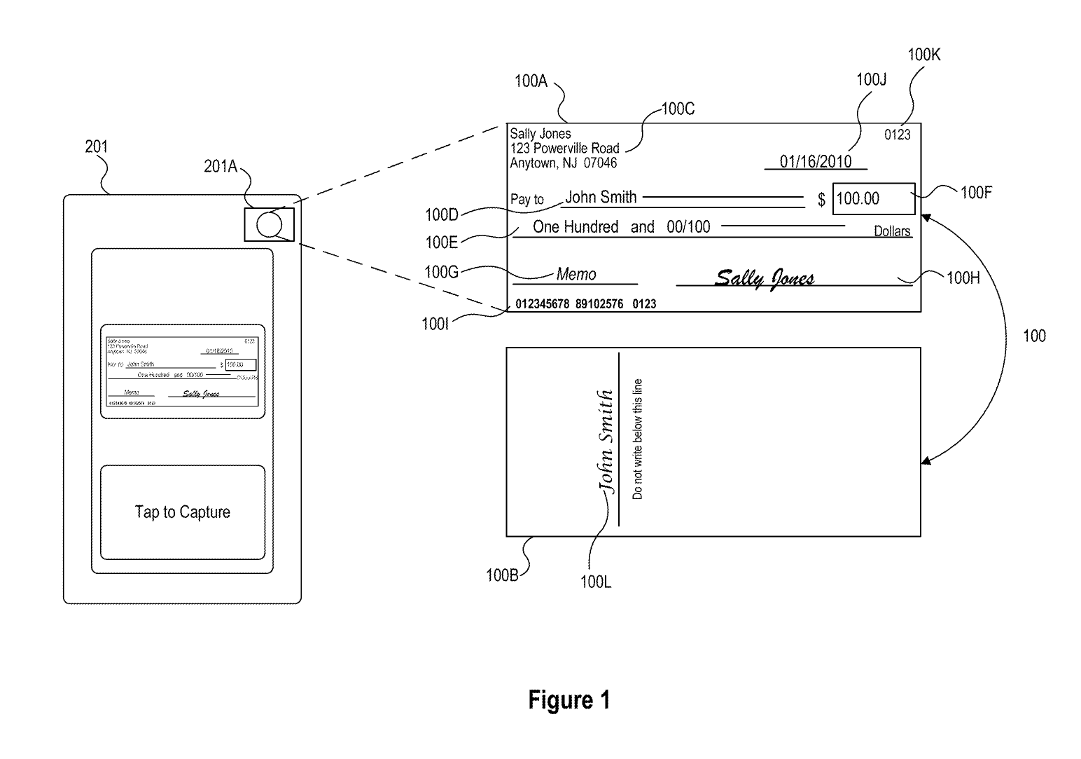

FIG. 1 shows an exemplary check 100 and mobile device 201, consistent with embodiments of the present disclosure. Check 100 includes check front 100A and check back 100B. Check 100 is an exemplary check such as paper checks used in the United States. For example, check 100 may be any of a payroll check, a government check, an insurance check, a financial dividend check, a cashier's check, a money order, a two-party personal check (e.g. a check endorsed by two parties for deposit by one of them), a government-issued tax refund check, a privately-issued tax refund check, a RAL (Refund Anticipation Loan) check, a rebate check, or the like.

Check front 100A may include, for example, written or printed information identifying payor 100C, payee 100D, amount (or “legal amount”) 100E, numerical amount (or “courtesy amount”)100F, memo line 100G, signature 100H, MICR line 100I, date 100J, and check number 100K. Check back 100B may include endorsement line 100L.

In some embodiments, payor 100C represents the entity (e.g., an individual, a couple, a corporation, an organization, or the like) that issued the check. The entity represented by payor 100C also represents the entity from whose account the amount of the check will be deducted if the check is cashed.

In some embodiments, payee 100D represents the entity (e.g., an individual, a couple, a corporation, an organization, or the like) that the check is issued to. Payee 100D may also be known, colloquially, as the entity that the check is “made out to.” Payee 100D, in some embodiments, may be an entity that is designated to cash the check (e.g., a person accepting payment for services he has performed), may be an intermediary that is designated to accept the check on behalf of another individual (e.g., a guardian), or may be an entity that is designated to receive the check but ultimately signs the check over to another individual for cashing (e.g., a person authorized to accept checks on behalf of an organization).

Amount 100E and numerical amount 100F, in some embodiments, represent the amount of money that the check is worth. Amount 100E, in some embodiments, may be written out in English. So, for example, if payor 100C owes payee 100D one hundred United States dollars ($100.00 USD), payor 100C can issue a check that states “One Hundred and 00/100 dollars” in amount 100E, and can list “$100.00” in numerical amount 100F. According to American Bankers Association (ABA) rules, in case of a discrepancy between amount 100E and numerical amount 100F, amount 100E would control. One of ordinary skill in the art would recognize that other arrangements are possible as well.

Memo line 100G is, in some embodiments, an optional note made by payor 100C. In some embodiments, memo line 100C represents the purpose of the check. Signature 100H, in some embodiments, represents a binding agreement that the entity represented by payor 100C will pay the payee the amount listed in 100E.

MICR line 100I, in some embodiments, is a line of data indicating information about the account of payor 100C. For example, MICR line 100I may include a routing number (representing, e.g., the financial institution which holds the account), an account number (e.g., a unique numerical identifier representing the account of payor 100C), and a check number (e.g., a unique numerical identifier representing the number of check 100). The term MICR stands for Magnetic Ink Character Recognition technology. Thus, in some embodiments, MICR line 100I may be printed using a magnetic ink, for example, ink containing iron oxide or another magnetic element. Point-of-sale devices may use magnetic check reading devices (not pictured) to determine information about the account of payor 100C or check 100, even if the other text on check 100 is illegible.

Check back 100B may include, for example, endorsement line 100L. Endorsement line 100L enables payee 100D (or another person) to sign check 100 for deposit, to transfer check 100 to another (for example, to satisfy another debt owed by payee 100D to another person), or the like.,

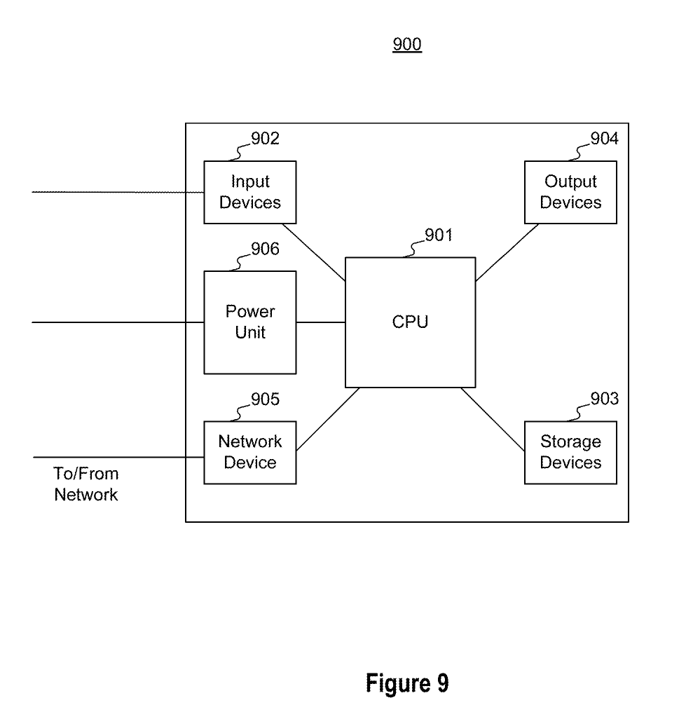

Mobile device 201 may be implemented, in some embodiments, as a mobile phone, smartphone, feature phone, or other mobile electronic device with wireless communication capabilities. In one embodiment, mobile device 201 contains a camera 201A or other sensing device for receiving visual information from the real world. For example, mobile device 201 may be implemented as depicted in FIG. 9. In some embodiments, camera 201A may be implemented as a single lens CCD- or CMOS-based camera. However, the particular type of camera 201A is not essential o operating or implementing the disclosed embodiments.

In some embodiments, mobile device 201 may capture an image of check 100 using camera 201A. As described with respect to other embodiments of this disclosure, mobile device 201 may capture the image and send it via a network, along with other information, in order to process a deposit transaction.

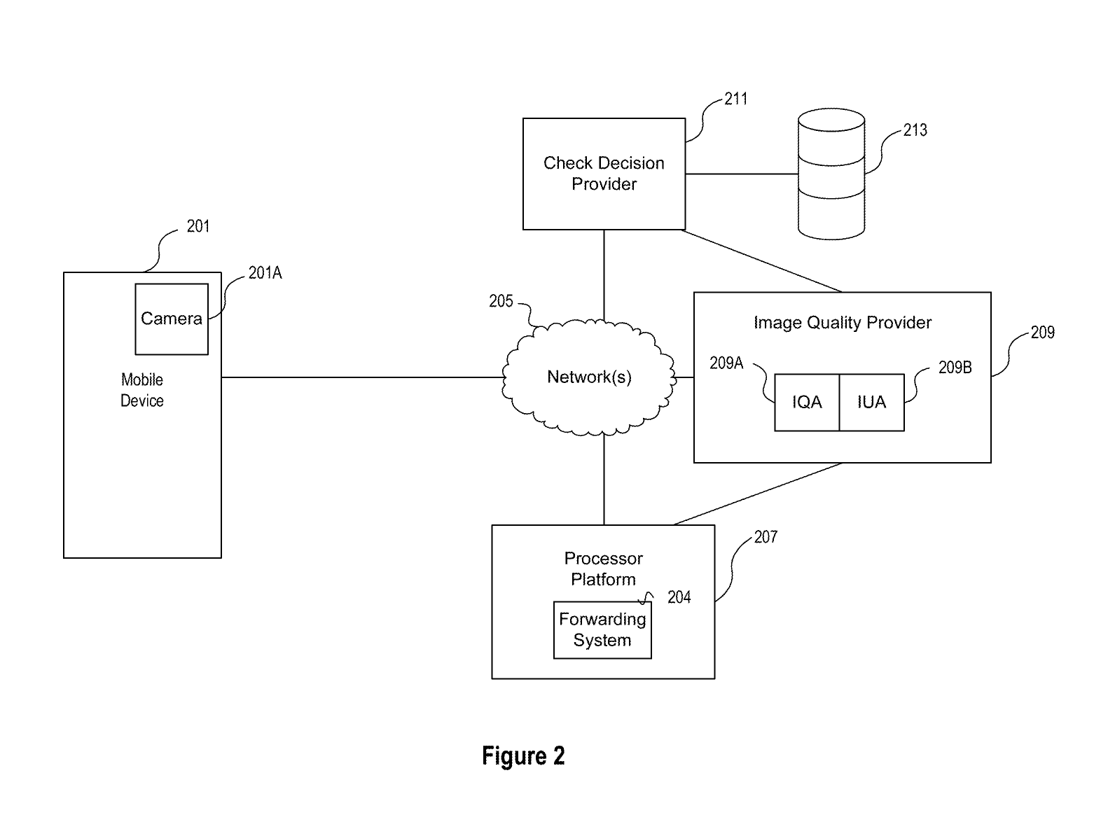

FIG. 2 shows an exemplary network layout, consistent with disclosed embodiments. FIG. 2 illustrates a mobile device 201, a processor platform 207, an image quality provider 209, a check decision provider 211, and a database 213, as well as a network 205 which interconnects these components.

Mobile device 201 may be configured to use disclosed embodiments to capture or send an image of a check (such as check 100 in FIG. 1) for deposit into a deposit account, onto a prepaid card, as payment towards a bill or debt, or the like. Mobile device 201 may also be associated with a consumer (not pictured) that owns or uses a deposit account.

Mobile device 201 may, in some embodiments, utilize camera 201A to take a picture of a check. In some embodiments, mobile device 201 may prompt a consumer to take two pictures, one each of both sides of the check. However, in other embodiments, only one side (e.g., the front) of the check need be imaged to effect a deposit.

Mobile device 201 may also, in some embodiments, prompt the consumer to enter other information about the check or the deposit. For example, mobile device 201 may prompt the consumer to enter or select information on the account into which the consumer wishes to deposit the check. Mobile device 201, in some embodiments, may also prompt the consumer to manually enter information represented on the check, such as the amount, payor, check number, MICR data, or the like.

Mobile device 201 may also prompt the consumer to select a type of funding option. For example, mobile device 201 may prompt the consumer to select one of an “Instant” or “Delayed” funding option. An instant funding option, in some embodiments, provides funding to the account associated with the consumer immediately upon receipt of an approval response for the check deposit transaction. This may yield higher risk for the account issuer. In some embodiments, in order to enable an instant funding option, processor platform 207 may provide funds to the consumer's account before a check has been fully settled (e.g., gone through a settlement process). In order to offset this risk, for example, processor platform 207, image quality provider 209, or check decision provider 211 may levy a fee on the deposit (such as a fixed fee, percentage, or combination) for using the instant funding option.

A delayed funding option, in some embodiments, provides funding to the account associated with the consumer after the passage of a period of time after the deposit is made. For example, a delayed funding option may not actually credit the consumer's account until 5 days have passed. This delay enables, for example, settlement of the check to take place before making the funds available in the account. This enables processor platform 207, image quality provider 209, and/or check decision provider 211 to reduce risk of a check bouncing before crediting the consumer's account with money.

Mobile device 201 also may be configured to enroll a consumer with systems enabling the disclosed embodiments. For example, enrollment processes may involve communicating with at least one of processor platform 207, image question provider 209, or check decision provider 211. Mobile device 201, in some embodiments, may prompt the consumer to enter information useful in enrolling. For example, mobile device 201 may prompt the consumer to enter full name, social security number, date of birth, phone number, full address, information concerning an identification document (e.g., a driver's license), or the like. In some embodiments, processor platform 207 or another entity may already possess this data.

When enrolling, mobile device 201 may be configured to use one of a trusted enrollment service or a standard enrollment service. In some embodiments, if mobile device 201 uses a trusted enrollment service, mobile device 201 may request less information from the consumer than it otherwise would have. For example, if mobile device 201 uses a trusted enrollment service, mobile device 201 may require the consumer to enter a social security number and last name, and only request the consumer to provide other elements (e.g., first name, date of birth, phone number, address). However, in some embodiments where mobile device 201 uses a non-trusted enrollments service, mobile device 201 may require the consumer to enter all of the above-mentioned information. A person having ordinary skill will recognize that not all embodiments require these particular data elements or in these particular combinations.

In some embodiments, whether mobile device 201 uses a trusted enrollment service or a standard (e.g., non-trusted) enrollment service depends on one or more factors. For example, mobile device 201 may utilize a trusted enrollment service if image quality provider 209 and/or check decision provider 211 determines that processor platform 207 (associated with mobile device 201) utilizes sufficiently robust enrollment procedures.

Processor platform 207 may be implemented as one or more computers storing instructions that, when executed by processor(s), perform processes for enrolling a consumer in a program to deposit checks using images of those checks, and that perform processes for receiving check images and constructing requests to clear, verify, and deposit the checks associated with the check images. In some embodiments, processor platform 207 may be operated by any of an account issuer, a financial institution, a bill issuer, or another entity that stores credits or debits for a consumer.

In some embodiments, processor platform 207 may be configured to enroll consumers in a check deposit program. For example, in some embodiments, processor platform 207 can receive an enrollment request from mobile device 201. Processor platform 207 can, after receiving the enrollment request, construct a second enrollment request for sending to image quality provider 209. The second enrollment request can include information about the consumer. For example, the second enrollment request can include full name, social security number, date of birth, phone number, full address, information concerning an identification document (e.g.) a driver's license), or the like. Processor platform 207 may be configured to determine whether mobile device 201 is using the above-mentioned trusted enrollment service or not. If so, processor platform 207 may send the last name and social security number to image quality provider 209 in the second enrollment request. In some embodiments, if mobile device 201 is not using the aforementioned trusted enrollment service, processor platform 207 may be configured to send all of the above-mentioned information to image quality provider. One of ordinary skill will understand that variants of these embodiments are possible. For example, other types of data may be required or requested, other types of enrollment services may be implemented, or the like, without departing from the spirit of the disclosed embodiments.

If processor platform 207 is operated by an account issuer, processor platform 207 may be configured to use the disclosed embodiments to receive images of checks from mobile devices. The image may comprise, for example, a back side of a check, a front side of the check, a MICR line of the check, or the like. Processor platform 207 may also be configured to receive other information about the check and at least one account identifier for deposit. Processor platform 207 may also be configured to deposit these checks into pre-paid accounts, to pay the amount of the check towards debts, or the like.

Processor platform 207 may determine whether the request to deposit the check would exceed one or more limits (such as limits on the number or the amounts of deposits during a time period, or the like). In some embodiments, if processor platform 207 determines that such a deposit would exceed at least one limit, processor platform 207 may send a message to mobile device 201, indicating that the transaction was declined. However, if processor platform 207 determines that the request would not exceed limits, processor platform 207 may construct a message approving the deposit to mobile device 201. The approval message may, in some embodiments, indicate fees that will be charged to the consumer or against the deposit. For example, as mentioned above, fees may be charged for particular funding options (e.g., instant or delayed).

Processor platform 207, in some embodiments, may send an image of a check and/or information associated with the check to either of image quality provider 209 or check decision provider 211. In some embodiments, processor platform 207 may send an image of the check (front, back, or both sides) and other information (e.g., the amount of the check, the payee, the payor, the check number, MICR data, or the like) to image quality provider 209 for processing. Based on a response from either of image quality provider 209 or check decision provider 211, processor platform 207 may deposit the check into an account associated with the consumer, may delay the deposit of the amount of the check into the account, may decline to deposit the amount of the check into the account, may send an approval or declination message to the consumer and/or mobile device 201, or the like.

In some embodiments, based on a declination response received from either of image quality provider 209 or check decision provider 211, processor platform 207 may send either of a “hard” or a “soft” declination message (“decline”) to mobile device 201. In some embodiments, hard declines may represent a high-severity reason for a declination. Soft declines may represent reasons of relatively lower severity.

In some embodiments, a hard decline may indicate that the risk in accepting the deposit is too high, that there is a system error, that a check deposit has been reversed or is of an unapproved type, that the deposit account associated with the consumer has an error, that the consumer is a high-risk consumer, that the consumer's identification does not match or is unacceptable, or the like. Processor platform 207 may send a hard decline if image quality provider 209 or check decision provider 211 determines that the reasons for declining the deposit are of a relatively high severity.

In some embodiments, processor platform 207 may send a “soft” decline if image quality provider 209 or check decision provider 211 sends a declination response indicating a lower level of risk than a situation that would lead to a “hard” decline. For example, a soft decline may indicate a medium level of risk, elements missing from a deposit request or other communication, a MICR read error, a duplicate transaction, a system timeout, or the like. One of ordinary skill will understand that the particular reasons associated with each type of declination are not restrictive and are not intended to include only these reasons.

In some embodiments, a soft decline may indicate that mobile device 201 may attempt the deposit request again, and/or that the consumer may consider alternate options for initiating the transaction. For example, if the consumer selected an instant funding option for the check and received a soft decline, mobile device 201 may present the consumer with the option to try the deposit again using a delayed funding option. In some embodiments, a hard decline may indicate to mobile device 201 that neither mobile device 201 nor consumer should attempt the deposit again, because it will be declined.

Processor platform 207 may also comprise forwarding system 204. Forwarding system 204, in some embodiments, may be implemented as one or more computers or software programs for receiving, sending, or forwarding data between various devices in FIG. 2, including mobile device 201 and image quality provider 209.

Image quality provider 209, in some embodiments, may be implemented as one or more computers for processing a received check image. Image quality provider 209 may also be configured to perform image quality analysis of check images, for example, to authenticate the images and determine whether they are of sufficient quality or are legitimate enough to allow deposit. In some embodiments, image quality provider 209 may use Optical Character Recognition (OCR) or other image recognition technology to read information in check images.

In some embodiments, image quality provider 209 may also be configured to process enrollment requests from processor platform 207. In some embodiments, mobile device 201 may receive a request to enroll from a consumer, and may generate and send an enrollment request to processor platform 207. Processor platform 207 may forward this request to image quality provider 209. Image quality provider 209 may be configured to process enrollment requests and forward them to check decision provider to perform authorization processes.

Image quality provider 209 may also receive enrollment requests from processor platform 207. In some embodiments, image quality provider 209 may be configured to receive the enrollment requests and forward them to check decision provider 211.

In some embodiments, image quality provider 209 may be composed of multiple computers or software programs configured to perform image analysis. In some embodiments, image quality analysis provider 209A (e.g. a first of the computers/software programs that compose image quality provider 209) may perform an image quality analysis of received check images. Image quality analysis may comprise a number of tests. In some embodiments, image quality analysis provider 209A may determine that a check deposit request passes the image quality analysis if the check deposit request passes all of a set of tests, and may determine that the check deposit request fails image quality analysis if the check deposit request passes less than all of a set of tests.

For example, image quality analysis provider 209A may perform a first test of whether an image is acceptable for deposit. Determining whether an image is acceptable for deposit may comprise determining whether a check image meets or exceeds threshold values for focus, whether a check image is able to be cropped, whether the check image is straight (e.g., the check is not slanted or askew relative to the frame of the check image), whether the lighting is sufficient for reading the check (e.g., the information printed or written on the check is not washed out by too much light), or the like. Image quality analysis may also include determining whether the image is focused enough to read the information printed or written on its front or back sides. If image quality analysis provider 209A determines that the check image is not acceptable for deposit, image quality analysis provider 209A may determine that the check deposit request fails this test.

As another exemplary test, image quality analysis provider 209A may also determine whether the MICR line is legible enough to be read. For example, a MICR line (such as MICR line 100I in FIG. 1) may be smudged, overwritten, torn, or otherwise difficult for image quality provider 209 to interpret. Image quality analysis provider 209A could determine that a MICR line is unreadable in the image, and may send a communication to mobile device 201, requesting the consumer to retake the check image, to clean the MICR line area of the check, or the like. If image quality analysis provider 209A cannot read the MICR line, image quality analysis provider 209A may determine that the check deposit request fails this test.

As another exemplary test, image quality analysis provider 209A may also determine whether an endorsement (e.g., a signature, stamp, or other marking) is present on the back side of the check. For example, in order to deposit a check, a bank or other depositing/receiving institution may require an endorsement on the back side of the check. The endorsement is a representation that the holder of the check (e.g., the person to whom the check is “made out”) has assigned the check and its value to the bank or other depositing/receiving entity for deposit. This enables the bank to collect the amount printed on the check and to deposit that amount (less any fees, etc.) in the account of the person who endorsed the check. If image quality analysis provider 209A determines that there is no endorsement on the check, image quality analysis provider 209A may determine that the check deposit request fails this test.

In some embodiments, image quality analysis provider 209A may also require a check image to pass any or all of the above tests before being approved. Upon failing any or all of the tests, image quality analysis provider 209A may send an error message to processor platform 207 and/or mobile device 201. The error message may indicate, for example, that the quality of the check image is insufficient for deposit. In some embodiments, mobile device 201 may request the consumer to capture another image of the check and attempt the deposit again. Mobile device 201 may suggest that the consumer, for example, flatten the check, clean the check, erase any stray marks on the check, focus the camera better, frame the check better, take the picture from either closer or further away, or the like.

In some embodiments, upon passing all or a subset of a set of tests, image quality analysis provider 209A may send a message to image usability analysis provider 209B (e.g. a second of the computers/software programs that compose image quality provider 209), indicating that the check image passed an image quality analysis process. Image quality analysis provider 209A may also send the check image to image usability analysis provider 209B.

In some embodiments, image usability analysis provider 209B may perform an image usability analysis of received check images. Image usability analysis, in some embodiments, may comprise one or more tests on the check image. In some embodiments, image usability analysis provider 209B may determine that a check deposit request passes the image usability analysis if the check deposit requests passes all of a set of tests, may determine that the check deposit request requires manual image review if the check deposit request passes some of a set of tests, and may determine that the check deposit request fails image usability analysis if the check deposit request passes none of a set of tests.

As one exemplary test, image usability analysis provider 209B may determine whether the courtesy amount and/or the legal amount in the check image are able to be recognized and determined with a high degree of confidence. For example, in FIG. 1, numerical amount 100F (“$100.00”) may represent the courtesy amount. A “legal amount” may comprise the printed amount of the value of the check. For example, in FIG. 1, amount 100E (“One Hundred and 00/100 Dollars”) may represent the legal amount. If either or both of the courtesy amount or legal amount in the check image cannot be recognized with a high degree of confidence, image usability analysis provider 209B may determine that the check deposit request fails this test.

As another exemplary test, image usability analysis provider 209B may also determine whether the courtesy amount and legal amount in the check image match one another. If the legal amount represents a different value from the courtesy amount (e.g., the courtesy amount reads “$1,500.00” while the legal amount reads “Fifteen and 00/100 Dollars”), in some embodiments, image usability analysis provider 209B may determine that the check deposit request fails this test.

Image usability analysis provider 209B may also determine whether the amount written or printed on a check image is different from an assertion of the value of the check. For example, as part of creating the original check deposit request, mobile device 201 may prompt a consumer to enter the value of the check (for example, “$100.00”). If image usability analysis provider 209B determines that information printed on the check (e.g., the legal amount or the courtesy amount) differs from the amount entered by the consumer, image usability analysis provider 209B may determine that the check deposit request does not pass this test.

Image usability analysis provider 209B may also determine whether any information is missing from the check image. For example, image usability analysis provider 209B may determine that the legal amount (e.g., amount 100E in FIG. 1—“One Hundred and 00/100”) is missing, that the payee (e.g. payee 100D—“Pay to John Smith”) is missing, or that any other portion of a check is missing in the check image. In some embodiments, if image usability analysis provider 209B determines that at least one field of information is missing in the check image, image usability analysis provider 209B may determine that the check deposit request does not pass this test.

While some embodiments comprise multiple computers or software programs, in other embodiments, image quality analysis provider 209A and image usability analysis provider 209B may be implemented as a single computer or software program.

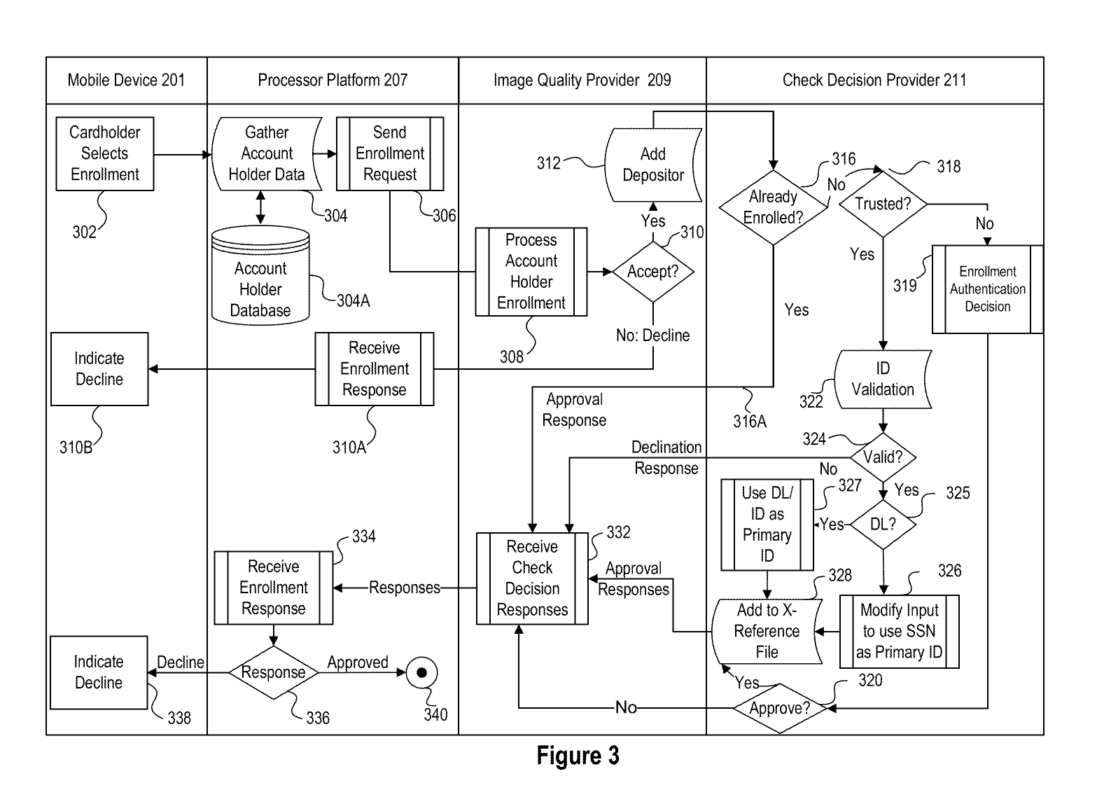

In some embodiments, and as explained below with respect to FIGS. 3-8B, image quality provider 209 may communicate with check decision provider 211 to provide the check image or to forward enrollment requests from mobile device 201 or processor platform 207.

Check decision provider 211 may be implemented as one or more computers for analyzing the requested deposit. Check decision provider 211, in some embodiments, may be configured to receive enrollment requests from one or more of mobile device 201, processor platform 207, or image quality provider 209. In some embodiments, check decision provider 211 may receive enrollment requests and determine whether the enrollment request comes from a mobile device using a trusted or non-trusted enrollment service. In some embodiments, if check decision provider 211 determines that mobile device 201 is using a trusted enrollment service, check decision provider 211 may be configured to enroll the consumer with minimal or no verification of the provided information. In some embodiments, the process of enrollment comprises check decision provider 211 adding received information to a database of enrolled individuals, such as database 213.

In some embodiments, if check decision provider 211 determines that a received enrollment request generated using the trusted enrollment service includes optional information (for example, information on an identification document such as a driver's license), check decision provider may update database 213 to add the optional information to a record containing the consumer's information.

In some embodiments, if check decision provider 211 determines that a received enrollment request was generated using a non-trusted enrollment service, check decision provider 211 may attempt to verify the information in the received enrollment request to verify the identity of the consumer. For example, check decision provider 211 may be configured to match the received information against data sources of trusted identity information. Such data sources can comprise, for example, data sources comprising credit history data social security numbers, identification card information (such as drivers' licenses), name information (such as a given name, a family name, or a corporate name), or the like. If check decision provider 211 determines that at least some information in the received enrollment request matches information in one or more data sources, check decision provider 211 may determines that the consumer should be enrolled.

After attempting to verify the data in the received enrollment requests, check decision provider 211 may be configured to send a response approving or denying the enrollment request. Check decision provider 211 may send this response to image quality provider 209, and image quality provider 209 may send the response to processor platform 207. Processor platform 207 may send the response to mobile device 201. Some embodiments of this process are explained in further detail with respect to FIG. 3.

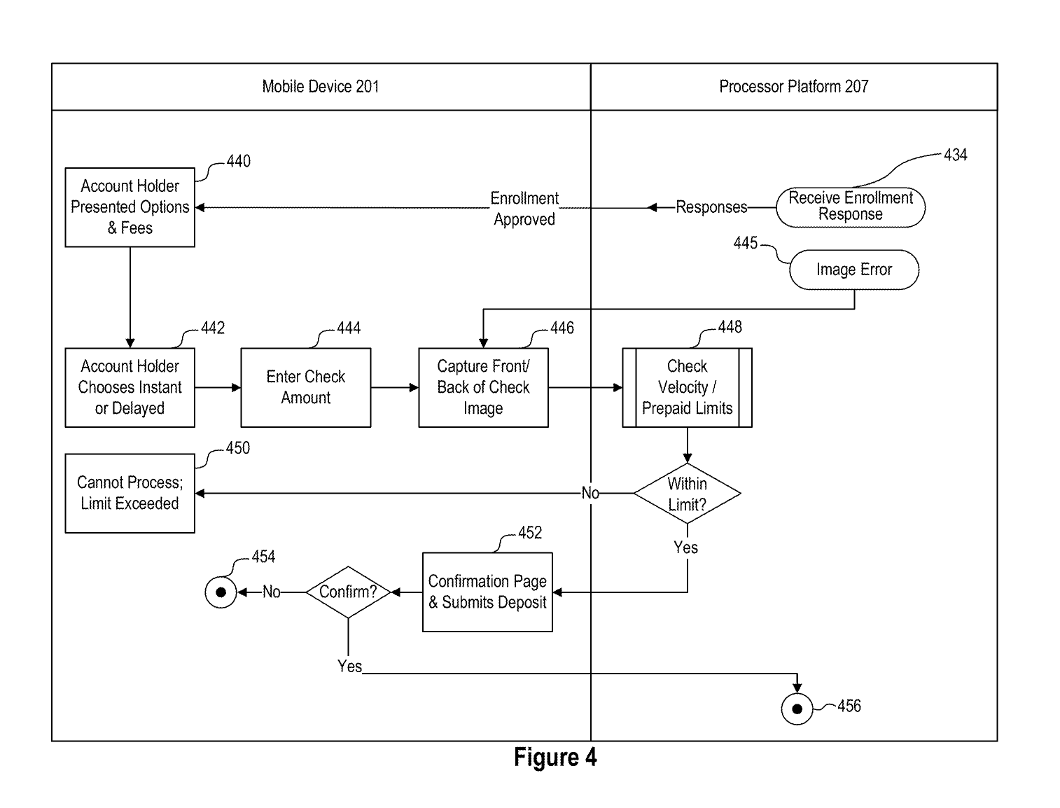

Check decision provider 211 may also be configured, in some embodiments, to render decisions on received check deposit requests. For example, check decision provider 211 can determine if a check passes a check decision authorization process, can begin a manual review of the check image and deposit, can initiate settlement processes, can process returned or bad checks, or can initiate collection processes for bad checks. Embodiments of these processes are explained with respect to FIGS. 4-8B.

Enrollment database 213 may store information on enrolled individuals. For example, enrollment database 213 may include personal information of consumers who have enrolled to utilize disclosed methods and systems for depositing checks using a mobile device. Some embodiments of the information requested and utilized are explained with respect to FIG. 3.

Network 205 may be implemented as any type of data network consistent with the disclosed embodiments. Each of mobile device 201, processor platform 207, image quality provider 209, or check decision provider 211, may connect to network 205 for communication with any or all other components in FIG. 2. Network 205 may be implemented, in some embodiments, as one or more networks that connect devices in the network layout of FIG. 2 for allowing communication between them. For example, as one of ordinary skill in the art will recognize, network 205 may be implemented as one or more of the Internet, a wireless network, a wired network, a cellular network, a satellite network, a local area network (LAN), or any other type of network that provides communications between one or more components in FIG. 2.

While processor platform 207, image quality provider 209, check decision provider 211, and enrollment database 213 are all shown as separate components, any subset of these may be implemented using a single computer, device, or software program.

FIG. 3 shows an exemplary process for enrolling a consumer, consistent with disclosed embodiments. In order to utilize a service implementing disclosed embodiments to, for example, deposit checks using check images, consumers may be required to enroll with the service. The enrollment process depicted in FIG. 3 is merely exemplary and is not required in all embodiments. One of ordinary skill will understand that variants of this process are possible without departing from the spirit of the disclosure.

In step 302, a consumer using mobile device 201 may initiate an enrollment process. In some embodiments, mobile device 201 may prompt the consumer to activate an enrollment process. In other embodiments, upon receiving a request to deposit a check using a check image, mobile device 201 may construct an enrollment message in order to enroll the consumer, without receiving an explicit request from the consumer. In any case, mobile device 201 may then send an enrollment request to processor platform 207.

In step 304, processor platform 207 may receive the enrollment request and gather data on the account holder. For example, if the consumer represents a prepaid card account holder, processor platform 207 may be configured to consult at least one database (such as account holder database 304A) or external databases to gather information about the consumer. For example, information gathered from databases could include, for example, a consumer's name, social security number, date of birth, phone number, address, or the like. This information, in some embodiments, would be provided by the consumer when originally signing up for an account with processor platform 207. However, in other embodiments, mobile device 201 may prompt the consumer to enter some or all of this information in step 302. In step 306, processor platform 207 may generate a new enrollment request with some or all of the consumer's information, and send the enrollment request to image quality provider 209.

The enrollment request may contain different information based on whether processor platform 207 is making the enrollment request using a trusted or a non-trusted enrollment service. In some embodiments, depending on the type of enrollment service, the format of the enrollment request may require some types of information, while other types of information may be optional. For example, if processor platform 207 is using a non-trusted enrollment service, processor platform 207 may be required to provide, as part of the enrollment request, at least one of a transaction ID (e.g., a unique identifier for the enrollment request), a chain ID (e.g., a unique identifier for processor platform 207 or for the company or individual operating processor platform 207), a station number (e.g., a unique identifier for the device implementing processor platform 207), a social security number for the consumer, a last name for the consumer, a date of birth for the consumer, an ID type for the consumer (e.g., an indication of a driver's license, military/government identification, or the like), or an ID number for the ID identified in the ID type field. The format of the enrollment request may further include, as optional data, information such as a first name, street address(es), city, state, or zip code of residence, or phone number.

In some embodiments, if processor platform 207 is using a trusted enrollment service, processor platform 207 may be required to provide a different set of information. For example, processor platform may be required to provide a transaction ID, a chain ID, a station number, a social security number for the consumer, a last name for the consumer, a date of birth for the consumer first name, street address(es), city, state, zip code, and phone. In some embodiments, processor platform 207 may optionally provider an ID type or ID number in the enrollment request, when processor platform 207 is using a trusted enrollment service.

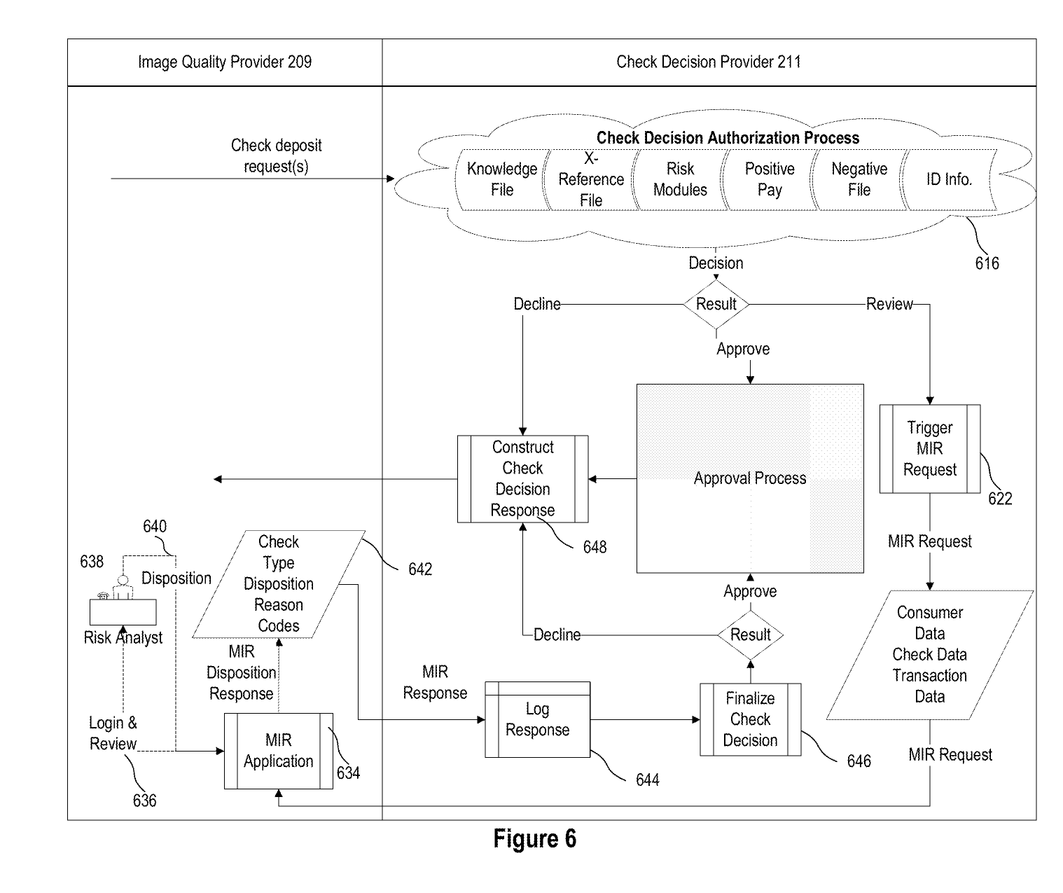

Image quality provider 209 may receive and process the enrollment request from processor platform 207 in step 308. For example, image quality provider 209 may be configured to process the enrollment request by validating the data received in the enrollment request against data sources (such as a knowledge file or cross-reference file, as illustrated in FIG. 6).

Image quality provider 209 may be configured to decline the enrollment in step 310, and may send a declination message to processor platform 207 in step 310A, which processor platform may forward to mobile device 201 in step 310B. In some embodiments, image quality provider 209 may send a declination message if image quality provider 209 is unable to verify the information in the enrollment request against data sources.

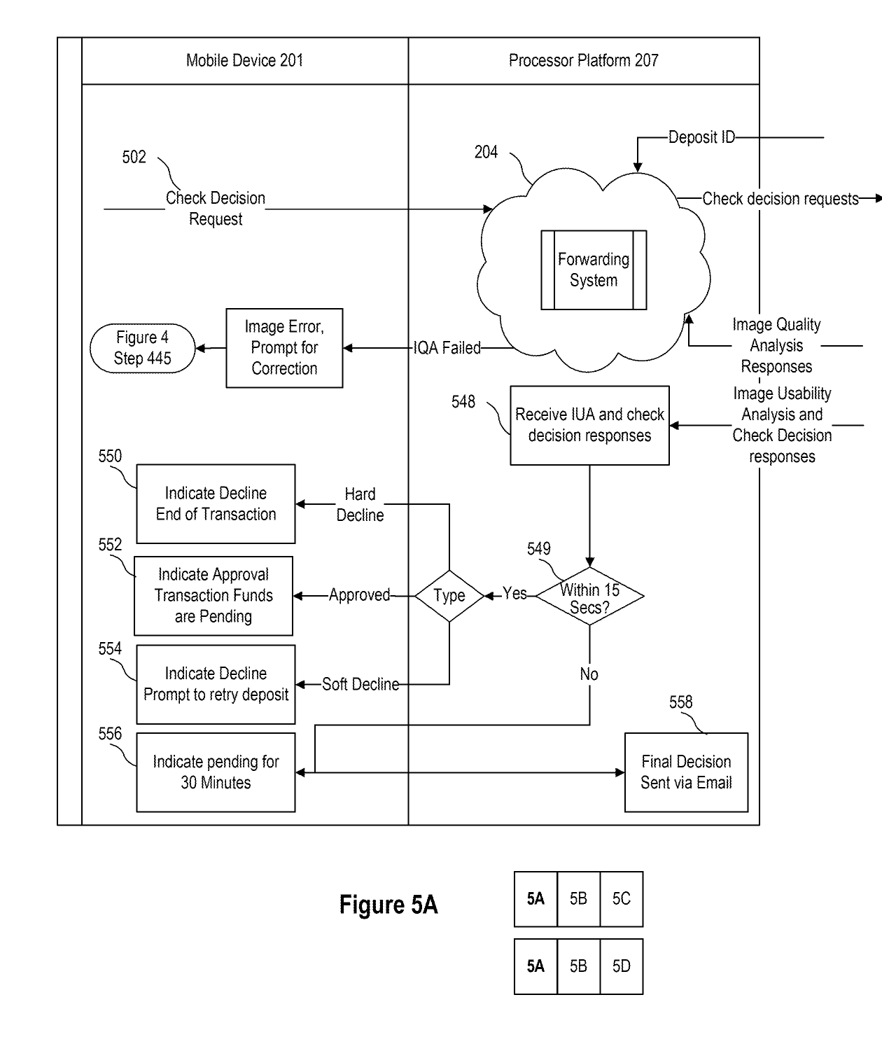

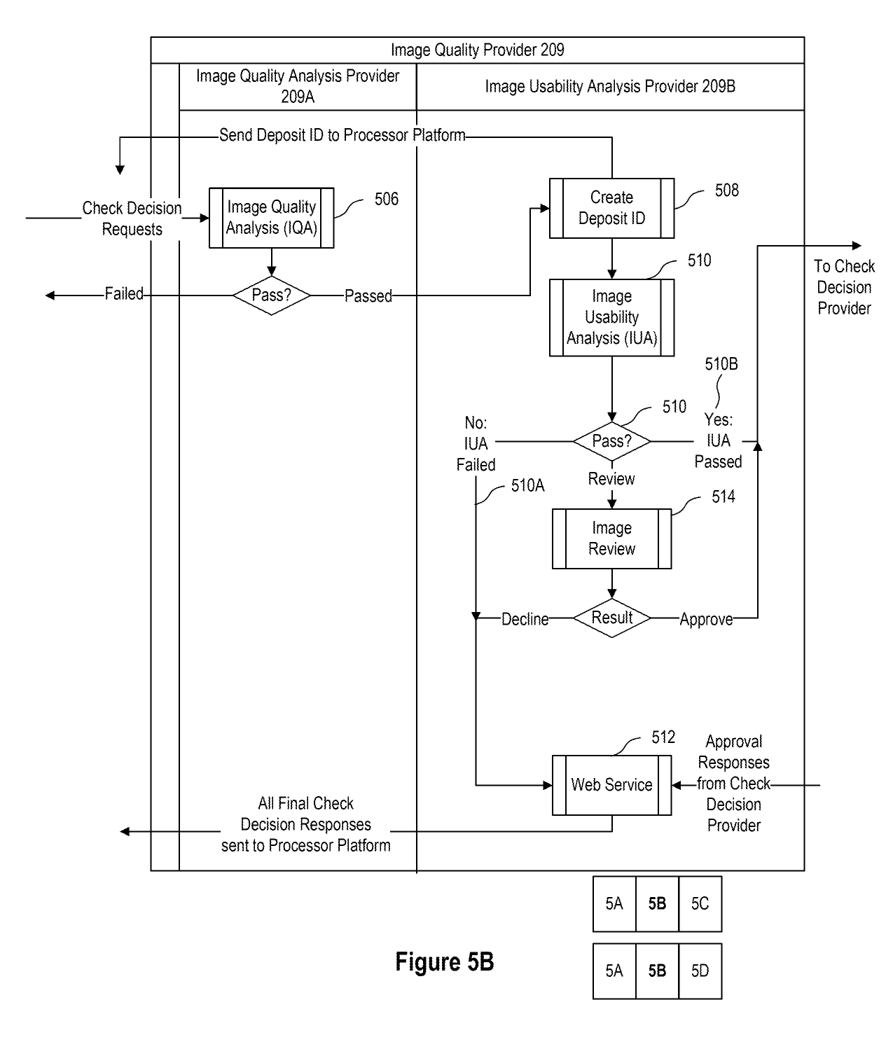

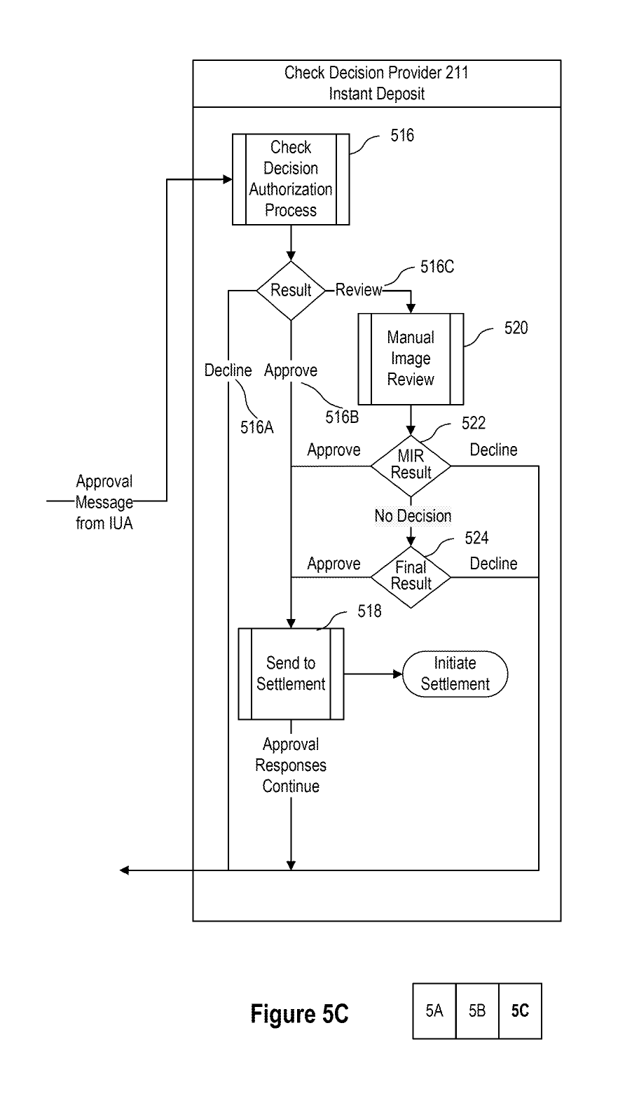

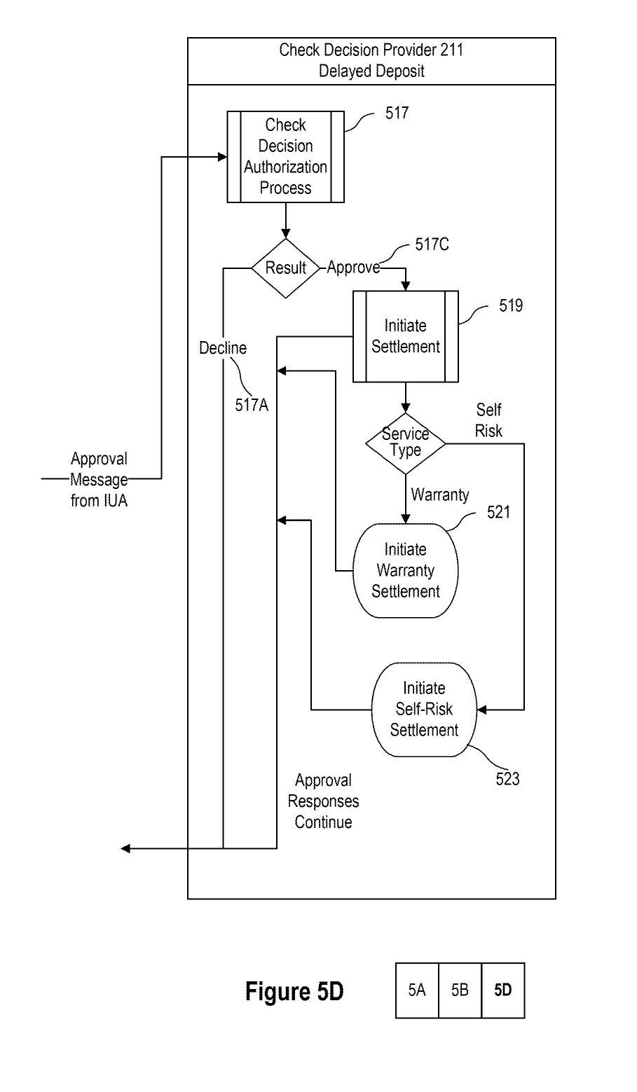

Image quality provider 209 may also be configured to determine that the enrollment request is valid and should be processed. In step 312, image quality provider 209 may be further configured to add the consumer to a list of valid depositors. For example, image quality provider 209 could add the consumer to a database of valid depositors (not shown), which image quality provider 209 can consult when receiving a check image for deposit (for example, as disclosed with respect to FIG. 5B). In step 312, image quality provider 209 may also be configured to send the enrollment request to check decision provider 211 for further processing.

Check decision provider 211 may receive the enrollment request in step 316. In step 316, check decision provider 211 may determine whether or not the consumer is already enrolled in the system. For example, check decision provider 211 may consult one or more database(s) (not pictured) of enrolled consumers to determine whether the consumer is already enrolled. If check decision provider 211 determines that the consumer is already enrolled, check decision provider 211 may send an approval response to image quality provider 209 in step 316A, indicating that the consumer is already enrolled and no new enrollment process would be necessary.

In some embodiments, if check decision provider 311 determines in step 316 that the consumer is not already enrolled to deposit checks using check decision provider 211 and image quality provider 209, check decision provider 211 may be configured to determine, in step 318, whether mobile device 201 is using a trusted enrollment service. For example, check decision provider 211 may determine that mobile device 201 is using a trusted enrollment service if processor platform 207 (associated with mobile device 201) uses robust authentication procedures for enrolling and/or authenticating consumers. For example, the authentication procedures of processor platform 207 may be determined to be robust if processor platform 207 has a good history of enrolling trustworthy individuals, is a frequent enroller of individuals, or is otherwise worthy of using a trusted enrollment service.

If check decision provider 211 determines that mobile device 201 is using a trusted enrollment service, check decision provider 211 may be configured to perform identity validation in step 322. In some embodiments, identity validation in step 322 may comprise attempting to validate the received information. This process, in some embodiments, may comprise checking details in the enrollment request (e.g. first and last name, social security number, date of birth, or the like) against internal data sources. For example, check decision provider 211 can check the information against credit history information, publicly available information (such as phone books or government records), proprietary data records, or the like. Identity validation, in some embodiments, may also comprise determining whether the received enrollment request contains all of the information required for the particular type of enrollment (e.g., a trusted enrollment process). In step 324, if the information is invalid, a declination response may be sent to image quality provider 209.

However, if in step 324, the information is valid, processing may continue to step 325 to determine whether a driver's license (or other identification document) was provided with the enrollment request. If so, check decision provider 211 utilizes the driver's license or other document in the enrollment process in step 327. For example, step 327 may comprise storing information about the identification document in an enrollment database, such as enrollment database 213 in FIG. 2. Check decision provider 211, in some embodiments, may use information about the identification document (such as an identifier or unique number) as a primary identifier for the consumer's record in the enrollment database. Check decision provider may then store the information in the enrollment request (including information about the identification document) in a cross-reference file in step 328, and may send an approval response to image quality provider 209. (Exemplary cross-reference files will be further explained below with reference to FIG. 6.)

However, if no driver's license or identification document is provided in the enrollment request (as determined in step 325), check decision provider may modify the enrollment request to utilize the social security number as an identifier for the consumer. After this modification in step 326, check decision provider 211 may, in step 328, add the modified enrollment request (with the social security number as the primary identifier for the consumer) to a cross-reference file. (Exemplary cross-reference files will be further explained below with reference to FIG. 6.) These steps, in some embodiments, enable check decision provider 211 to process check deposits and other transactions using a social security number received from mobile device 201. For example, a consumer may initiate a deposit request, as described below with respect to FIGS. 4 and 5A-5D, using his social security number as an identifier for his account.

After adding information regarding the consumer to a cross-reference file in step 328, check decision provider 211 may send an approval response to image quality provider 209, indicating that the consumer was properly enrolled to deposit checks using check images.

However, if in step 318, check decision provider 211 determines that mobile device 207 is not using a trusted enrollment process, check decision provider 211 may begin an enrollment authentication decision process in step 319. For example, check decision provider 211 can check the information in the enrollment request against credit history information, publicly available information (such as phone books or government records), proprietary data records, or the like.

In some embodiments, step 319 may involve check decision provider 211 consulting cross-reference files (such as those explained below with reference to FIG. 6) to determine whether a consumer has previously enrolled and/or is associated with another chain ID. For example, if information about the consumer (e.g., social security number, identification document information, last name, or date of birth) is already contained in the cross-reference file but with a different chain ID associated with it, check decision provider 211 may determine that the consumer should be enrolled based on the presence of his information associated with another chain ID.

If, at step 320, check decision provider 211 determines that the enrollment authentication passed, check decision provider 211 may, in step 320, add information from the enrollment request to a cross-reference file. (Exemplary cross-reference files will be further explained below with reference to FIG. 6.) These steps, in some embodiments, enable check decision provider 211 to process check deposits and other transactions using a social security number received from mobile device 201. If, however, check decision provider 211 determines that the enrollment authentication in step 319 did not pass, check decision provider 211 may send a declination message to image quality provider 209, in step 320.

Image quality provider 209, in some embodiments, may receive an approval response in steps 316A, 320, or 328, or a declination response in step 324. Depending on the response received, image quality provider 209 may generate and send an appropriate corresponding response to processor platform 207. The response sent by image quality provider 209, in some embodiments, indicates the result of the original enrollment request sent by mobile device 201 in step 302.

In some embodiments, upon receiving a response in step 334, processor platform 207 may determine the content and indication of the response (e.g., an approval or declination of the enrollment request). If processor platform 207 determines that the response indicates a declination of the enrollment request sent in step 302, processor platform 207 may generate or forward a declination message (such as the response received in step 334) in step 338, to mobile device 201, indicating to the consumer that the enrollment request was denied. In some embodiments, processor platform 207 may begin performing steps represented in FIG. 4, at step 340, upon receiving an indication that the enrollment request was successful.

FIG. 4 shows an exemplary process for initiating a check deposit consistent with the disclosed embodiments. In some embodiments, upon receiving an indication that the consumer using mobile device 201 is enrolled as in step 434, processor platform 207 may be configured, in step 434, to send an indication to mobile device 201 that the enrollment request was successful.

Mobile device 201 may be configured to receive an indication that the enrollment request was successful in step 434. Upon receiving the indication, mobile device 201 may, in step 440, display a notice to the consumer or account holder indicating options for check deposit and associated fees. As one of ordinary skill will understand, different options for depositing checks have different fees associated therewith. For example, an instant funding option may require the consumer to pay a fee (a fixed fee, a percentage of the deposit amount, or the like) in order to deposit the check, while a delayed funding option may not require the consumer to pay a fee or may require a lower fee than the instant funding option. One or ordinary skill in the art will understand that multiple types of fees and funding options are possible.

Upon displaying options in step 440, mobile device 201 may receive selection(s) from the consumer in step 442. For example, the consumer may select one of an instant or a delayed funding option. As mentioned above with respect to FIG. 2, an instant funding option, in some embodiments, provides funding to the consumer's account immediately upon or shortly after receipt of an approval response for the check deposit transaction. This may yield higher risk for the account issuer, because processor platform 207 may provide funds to the consumer's account before a check has actually cleared or been fully received by the account issuer. In order to offset this risk, for example, some embodiments of processor platform 207 charge the consumer a fee (such as a fixed fee, percentage, or combination) for using the instant funding option.

A delayed funding option, in some embodiments, provides funding to the account associated with the consumer after the passage of a period of time after the deposit is made. For example, a delayed funding option may not actually credit the consumer's account until some days have passed. This enables processor platform 207 to reduce risk of a check bouncing, before crediting the consumer's account with money.

Upon receiving a selection of a funding option in step 442, mobile device 201 may, in some embodiments, prompt the consumer to enter the amount of the check. For example, this could be an amount printed or written on the front side of the check, indicating the amount that a payor wishes to transfer to the receiver of the check.

Mobile device 201 may also, in step 446, capture an image of the front and/or back sides of the check. In some embodiments, mobile device 201 may utilize a camera, such as camera 201A, to capture an image.

In some embodiments, mobile device 201 may not prompt the consumer to enter the amount of the check in step 444. Rather, mobile device 201 may attempt to determine the amount of the check based on the check image captured in step 446. In some embodiments, mobile device 201 may utilize known or as-yet-unknown Optical Character Recognition (OCR) systems to determine the amount of the check. For example, if a check (such as check 100 in FIG. 1) has printed lines for amount 100E and numerical amount 100F, mobile device 201 may be configured to determine the amount of the check based on the information printed on the check. Mobile device 201 may also request the consumer enter the amount of the check if the check is not clear enough for recognition. For example, after capturing images of the check in step 446, mobile device 201 may continue to step 444 and prompt the consumer to enter the amount, if mobile device 201 is unable to determine it.

In some embodiments, mobile device 201 may perform the processes represented in step 446 of capturing the check images after an image error has occurred. For example, as described below with respect to FIGS. 5A-5D, image quality provider 209 may determine that check images are not clear enough to be deposited. For example, image quality provider 209 may determine that the check is not clear enough because of focus, lighting, or the like. In step 445, image quality provider 209 may send a message to mobile device 201 indicating that the image is not clear enough for use in step 445, and mobile device 201 may prompt the consumer to retake the images of the check in step 446. For example, in some embodiments, mobile device 201 may prompt the consumer to take a larger or smaller image of the check, to hold mobile device 201 still or place it on a solid surface when capturing an image of the check, to ensure that the entire check is viewable in the captured image, to use a zoom feature on mobile device 201 when capturing the image, or the like.

After receiving or determining the amount of the check, mobile device 201 may forward the image in step 448 to processor platform 207. In some embodiments, mobile device 201 may forward the image with other information concerning the deposit. For example, mobile device 201 may forward the image in a message including information about the consumer (e.g., social security number, name, address, account number, or the like), information on a preferred funding options (e.g., instant or delayed), information on the check (e.g., the amount asserted by the consumer in step 444 or an otherwise-determined amount), or the like.

Upon receiving the communication from mobile device 201, processor platform 207 may determine whether completing the deposit would exceed any limits on the consumer's account. In some embodiments, processor platform 207 may be configured to determine whether completing the deposit would exceed a limit on the amount of money that one consumer may attempt to deposit during a period of time. For example, processor platform 207 may limit a consumer to depositing $100.00 per day or $1,000.00 per week. In some embodiments, processor platform 207 may be configured to determine whether completing the deposit would exceed a limit on the number of deposits during a time period. For example, processor platform may limit each consumer to depositing 3 checks per day or 15 checks per week. In other embodiments, processor platform 207 may be configured to determine whether completing the deposit would exceed other limits as well (e.g., no more than 3 checks from a single payor during a single week). In some embodiments, if processor platform 207 determines that such a deposit would exceed at least one limit in step 448, processor platform 207 may send a message to mobile device 201 in step 450, indicating that the transaction was declined for exceeding at least one limit.

However, if processor platform 207 determines that the request would not exceed any limits, processor platform 207 may construct a message approving the deposit and send it to mobile device 201 in step 452. The approval message may, in some embodiments, indicate terms of the deposit, fees that will be charged to the consumer or against the amount of the deposit, or the like. As mentioned above, fees may be charged for particular funding options (instant or delayed). In addition, different funding options are associated with different amounts of time for funds to become available in an account. For example, an instant funding option may require higher fees for use of the service, but may process the deposit immediately after verification and acceptance (leading to faster deposit in the consumer's account).

In some embodiments, the approval message may also request confirmation from mobile device 201 to proceed with the deposit.

Mobile device 201 may, in some embodiments, receive the above-mentioned confirmation in step 452 and display information to the consumer. For example, mobile device 201 may indicate to the consumer that the consumer is required to accept or decline the deposit. If the consumer declines the deposit, mobile device 201 may proceed to step 454. The deposit request is not processed, and mobile device 201 can begin the process again. However, if the consumer accepts the deposit, mobile device 201 may send a confirmation message to processor platform 207 in step 452, indicating that the consumer wishes to process the deposit and accepts the terms of the deposit. The message, in some embodiments, may also contain an indication of an instant or delayed funding option as selected by the consumer. Processor platform 207 may receive the confirmation message from mobile device 201 in step 456.

FIGS. 5A, 5B, 5C, and 5D show portions comprising an exemplary deposit process, consistent with the disclosed embodiments. In order to explain the exemplary deposit process, each of the Figures will be referenced together.

Beginning in step 502 of FIG. 5A, mobile device 201 may, as previously mentioned with respect to step 456 of FIG. 4, send a message confirming a check deposit request. Mobile device 201 may send this message to processor platform 207. Processor platform 207 may receive this indication at a forwarding system 204. Forwarding system 204, in some embodiments, may be implemented as software implemented on processor platform 207 or may be implemented as one or more separate computer(s). Forwarding system 204 may be configured as a separate computer or software program implemented on processor platform 207 to receive and send information between the various parties and devices in FIGS. 5A-5D.

Upon receiving the check decision request from mobile device 201 in step 502, forwarding system 204 may send the check decision request to image quality analysis provider 209A. The check decision request may include image(s) of a check for deposit (for example, the images received in step 408 of FIG. 4), information on the consumer and/or mobile device 201, or the like.

In FIG. 5B, at step 506, image quality analysis provider 209A may perform an image quality analysis. In some embodiments, the image quality analysis in step 506 may be similar to the image quality analysis performed by image quality analysis provider 209A in FIG. 2. If the image quality analysis process fails, image quality analysis provider 209A may send a response to forwarding system 204 at processor platform 207, indicating that the image quality analysis failed. In some embodiments, the response may list at least one reason that the analysis failed, and may indicate that mobile device 201 can attempt the deposit request again. In some embodiments, the response may include at least one reason why image quality analysis 506 failed. Processor platform 207 may forward this response to mobile device 201, as illustrated in step 506A of FIG. 5A.

In some embodiments, if the image quality analysis in step 506 is successful, image quality analysis provider 209A may forward the check decision request to image usability analysis provider 209B for further processing. In some embodiments, image usability analysis provider 209B may, in step 508, create a deposit identifier (or “deposit ID”) for the deposit request. This deposit ID may be forwarded back to processor platform 207, and in some embodiments, may indicate that the image quality analysis in step 506 was successful.

In some embodiments, image usability analysis 510 may be similar to the analysis performed by image usability analysis provider 209B in FIG. 2. If the image usability analysis process in step 506 fails, in some embodiments, image usability analysis provider may send a message to processor platform 207 using web service 512, in step 510A. The message may indicate that the image quality analysis process failed and may indicate reasons why it failed. Upon receipt of the message, processor platform 207 may, in some embodiments, send a message to mobile device 201, indicating that the image usability analysis process failed, and that mobile device 201 can attempt the deposit request again after, for example, capturing a new check image.

If the image usability analysis at step 510 is successful, image usability analysis provider 209B may send a message (step 510B) to check decision provider 211 indicating that the usability analysis passed. However, if the image usability analysis process does not fail or pass, but instead indicates that the check image should be manually reviewed, image usability analysis provider 209B may proceed to step 514 where the check image may be reviewed. For example, image usability analysis 510 may be unable to determine whether the check image is sufficient or contains all of the necessary information for deposit, because the check image is out of focus, cut off, tilted, or the like. In some embodiments, in such a situation, image usability analysis provider 209B may prompt a human operator to manually review the check image to determine whether the check is valid or not.

In some embodiments, manual image review process 514 may indicate receiving an indication that the check is valid or not valid, and may provide reasons for invalidity. In some embodiments, if a human operator determines that a check is invalid (for example, because the human operator determines that the check is a forgery, the check has been voided, or the check is otherwise not valid), the human operator may provide these reasons to image usability analysis provider 209B when declining to accept the check image.

If, in step 514, image usability analysis provider 209B receives an indication that the reviewed check is not valid, a declination message may be sent to processor platform 207 via web service 512. The message may indicate that the image quality analysis process and the manual review failed. Upon receipt of the message, processor platform 207 may, in some embodiments, send a message to mobile device 201, indicating that the image usability analysis process failed, and that mobile device 201 can attempt the deposit request again after capturing a new check image. In some embodiments, depending on the content of the received message, processor 207 may indicate to mobile device 201 that the deposit request should not be attempted again. For example, if the review in step 514 indicates that the check is fraudulent or void, processor platform 207 may indicate to mobile device 201 that the deposit request should not be attempted again.

If, in step 514, image usability analysis provider 209B receives an indication that the check image is valid (e.g., from a human operator manually reviewing the check image), image usability analysis provider 209B may send a message to check decision provider 211 indicating that manual review in step 514 passed.

In FIG. 5C, step 516, check decision provider 211 may receive a message indicating that a usability analysis passed (e.g., through automated usability analysis, as in step 510 of FIG. 5B, or through manual review, as in step 514 of FIG. 5B). In step 516, check decision provider 211 may be configured to perform a check decision authorization process, to determine whether the check represented by a check image is valid for deposit. Embodiments of an exemplary check decision authorization process are described below with respect to FIG. 6.

If check decision provider 211 determines, at step 516, that the check did not pass the authorization process, check decision provider 211 may send, at step 516A, a message to image quality provider 209 (in FIG. 5B) indicating that the check deposit was declined. In some embodiments, the message sent to image quality provider 209 may indicate the reason for the decline. For example, the message may include information referencing a problem with the check or check image, with one or more accounts associated with the deposit, with a system component necessary to process the deposit request, an unacceptably high level of risk, the check deposit request being a duplicate of a previous check deposit, or the like.

In some embodiments, the message sent to image quality provider 209 may comprise one of a “hard decline” or a “soft decline.” As described above with respect to FIG. 2, hard declines may represent a high-severity reason for a declination, and soft declines may represent reasons of relatively lower severity. A hard decline, for example, may indicate a high risk in accepting the deposit request, a system error, a reversed check or unapproved check type, an error associated with the consumer's deposit account, the consumer being a high risk consumer, a mismatch of the consumer's identification, or the like. In some embodiments, a soft decline may indicate a medium level of risk, such as elements missing from a deposit request or other communication, a MICR read error, a duplicate transaction, a system timeout, or the like. One of ordinary skill will understand that the particular reasons associated with each type of declination are modifiable and are not intended to include only these reasons.

A soft decline may, in some embodiments, be used to indicate that processor platform 207 and mobile device 201 may attempt the deposit request again. In some embodiments, a soft decline may also indicate that the consumer may consider alternate options for initiating the deposit request. For example, if the consumer selected an instant funding option for a check deposit request and received a soft decline, mobile device 201 may present the consumer with the option to try the deposit again using a delayed funding option. In some embodiments, a hard decline may indicate to mobile device 201 that neither mobile device 201 nor the consumer should attempt the deposit again.

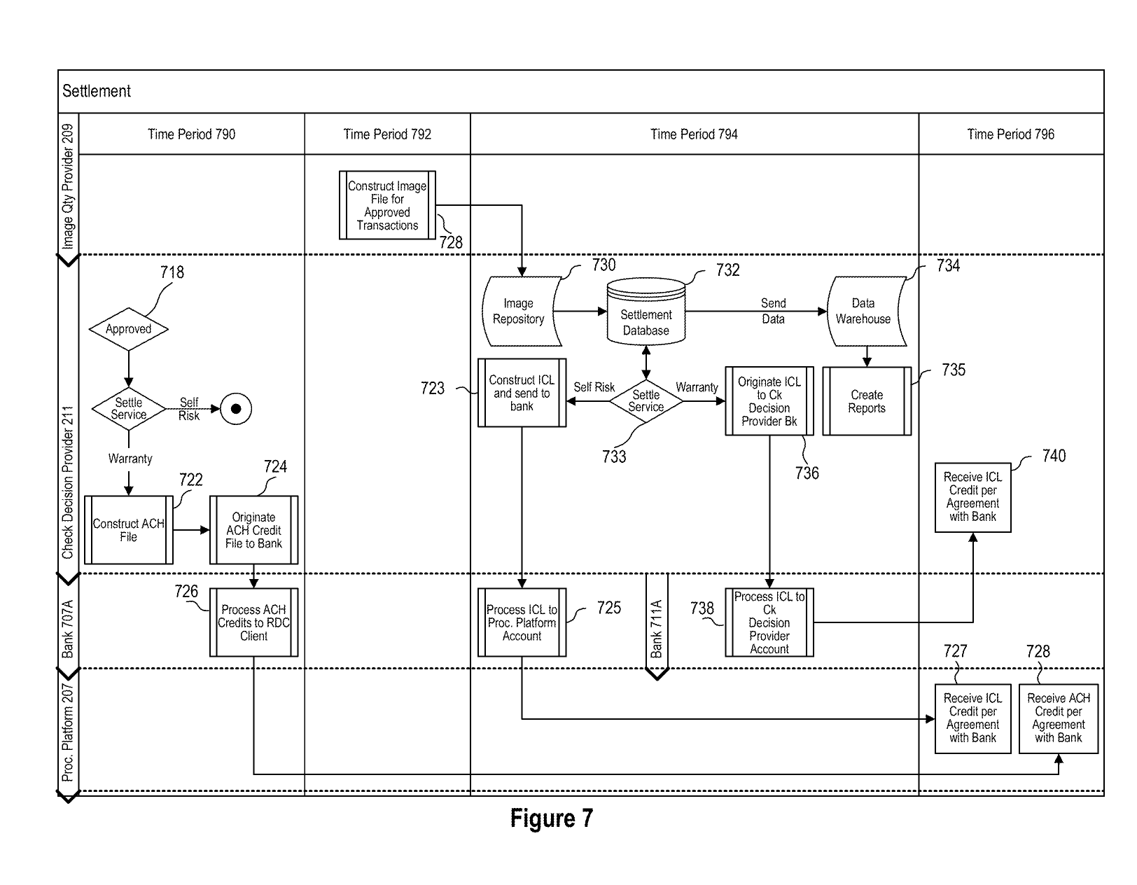

If check decision provider 211 determines that the check deposit passed the authorization process in step 516B, check decision provider 211 may initiate a settlement transaction in step 518. A settlement transaction, in some embodiments, may comprise initiating the depositing of a check associated with the check image into the account associated with the consumer and/or mobile device 201. Exemplary settlement processes are illustrated with respect to FIG. 7. Upon initiating the settlement process in step 518, check decision provider 211 may send a message to image quality provider 209 indicating that the check is in the process of settlement.

If check decision provider 211 determines that the check deposit requires review in step 516G, check decision provider 211 may initiate a Manual Image Review (“MIR”) process in step 520. In some embodiments, the manual image review may comprise a human operator (or “risk analyst”) manually reviewing the check image and the details of the deposit request. In one aspect, the risk analysis may be performed at or on behalf of image quality provider 209. As will be explained below with respect to FIG. 6, a risk analyst may perform an image review process to determine whether a check is sufficiently acceptable for deposit.

In some embodiments, check decision provider 211 may receive a result of the manual image review process in step 522. If the risk analyst determines that the check deposit should be approved, check decision provider 211 may receive input from the risk analyst indicating that the deposit request should be approved, and may continue to step 518 for settlement processing and reporting to image quality provider 209. If the risk analyst determines that the check deposit request should be declined, check decision provider 211 may receive input from the risk analyst indicating that the deposit request should be declined, and may send a message to image quality provider 209, indicating that the transaction was declined. If the risk analyst makes no decision, check decision provider 211 may perform further analyses of the check to determine whether it should be approved or not. For example, check decision provider 211 may initiate a second manual image review (e.g., from a second risk analyst), may verify the check against numerical limits (e.g., determining whether the check would exceed a limit on an amount of money that one consumer may attempt to deposit during a period of time or a limit on a number of deposits during a second period of time), or the like. In some embodiments, the checks may be approved based on these or other analysis mechanisms. A message approving or denying the check may be sent to web service 512 in FIG. 5B, and web service 512 may forward the message to processor platform 207.

Processor platform 207 in FIG. 5A, upon receiving a message from check decision provider 211 at step 548, may determine the content of the message. For example, the content of the message may indicate that the deposit request was declined with a hard decline. If so, in step 550, processor platform 207 may send a message to mobile device 201 indicating a hard decline. In some embodiments, this could indicate to mobile device 201 that the deposit request will not be approved, even it tried again. Processor platform 207 may also determine the content of the message to indicate a soft decline.

In some embodiments, processor platform 207 determining a soft decline may cause processor platform 207 to send a soft decline message to mobile device 201. In some embodiments, a soft decline may indicate to mobile device 201 that the deposit request can be tried again with different options (for example, using a delayed funding option). (This is represented by step 554.)

Processor platform 207 may also determine the content of the message to indicate an approval of the deposit request. In some embodiments, processor platform 207 determining that the message contains an approval could cause processor platform 207 to send an approval message to mobile device 201. (This is represented by step 552.)

In some embodiments, processor platform 207 may receive a message indicating that a response is not yet available. For example, if some amount of time has passed since the check image was originally sent in step 502 of FIG. 5A and/or forwarded by processor platform 207 (e.g., 15 seconds), processor platform 207 may determine that a decision on the deposit will be delayed. In such a situation, processor platform 207 may send a message to mobile device 201 indicating that the deposit request will be pending for a certain amount of time (for example, 30 minutes), as represented in step 556. In some embodiments, the approval/declination of the deposit request may be sent to the consumer (e.g., via email, text message, or the like) when the decision is finalized and sent to processor platform 207.

FIG. 5D is a flow diagram representing an alternative exemplary portion of a deposit process, consistent with disclosed embodiments. In some embodiments, one of ordinary skill can understand that FIG. 5D represents a process that can be operated by one or more computers in place of the processes in FIG. 5C. For example, while FIG. 5C may represent steps taken by check decision provider 211 when a consumer using mobile device 201 selects an instant funding option, FIG. 5D may represent the steps taken when the consumer selects a delayed funding option.

In FIG. 5D, step 517, check decision provider 211 may receive a message indicating that a usability analysis passed (e.g., through automated usability analysis, as in step 510 of FIG. 5B, or through manual review, as in step 514 of FIG. 5B). In step 517, check decision provider 211 may be configured to perform a check decision authorization process, to determine whether the check represented by a check image is valid for deposit. An exemplary check decision authorization process is described below with respect to FIG. 6.

If check decision provider 211 determines, at step 517, that the check did not pass the authorization process, check decision provider 211 may send, at step 517A, a message to image quality provider 209 (in FIG. 5B) indicating that the check deposit request was declined. Check decision provider 211 may also send messages as described above with respect to FIG. 5C. For example, in some embodiments, the message sent to image quality provider 209 may indicate the reason for the decline, may indicate a hard or soft decline, or the like.

If check decision provider 211 determines that the check deposit passed the authorization process in step 517B, check decision provider 211 may initiate a settlement transaction in step 519. A settlement transaction, in some embodiments, may comprise initiating the depositing of a check associated with the check image into the account associated with the consumer and/or mobile device 201. Exemplary settlement processes are illustrated with respect to FIG. 7. In some embodiments, check decision provider 211 may, in step 519, determine whether the settlement process for this deposit involves warranty or self-risk processing. In some embodiments, concurrently with at settlement processes in step 519, check decision provider 211 may send an approval response, indicating that the check image was approved, to web service 512 (in FIG. 5B).

As mentioned above, risk adjustment and assignment for check deposit requests can be accomplished in multiple ways. Two examples of settlement services for mitigating, assigning, and adjusting risk include warranty processing and self-risk processing. Warranty processing, in some embodiments, indicates that an entity performing check decision authorization would assume responsibility for the check, by purchasing the check for its face value. In some embodiments, the check can be purchased by check decision provider 211, by sending a credit from provider 211 to the consumer before finding out whether the check has settled.

So, if the check is fraudulent, bounces, or is otherwise uncollectable, the entity operating check decision provider 211 could, in some embodiments, perform recovery processes to recover the amount from the consumer that deposited the bad check. For instance, this could involve initiating a collections process with a collections agency.

In some embodiments, self-risk processing may involve the account issuer (e.g., the entity operating processor platform 207 in FIG. 5A) “owning” the risk associated with the check deposit. So, if the check is later found to be fraudulent, bad, later bounces, or is otherwise uncollectable, the entity operating processor platform 207 could, in some embodiments, perform recovery processes to recover the amount from the consumer that deposited the bad check. For instance, this could involve initiating a collections process with a collections agency.

The choice of which service (e.g., warranty or self-risk) to use may be decided by parties represented in FIGS. 5A-5D. For example, the particular type of service could be selected by one of an account issuer (e.g., the entity operating processor platform 207), an image quality provider (e.g., an entity operating image quality analysis provider 209A or image usability analysis provider 209B), or a check decision provider (e.g., the entity operating check decision provider 211).

After determining which settlement service (e.g. warranty or self-risk) should be used, check decision provider 211 may initiate the corresponding settlement process. For example, if check decision provider 211 determines that a warranty settlement service should be used to process this deposit, check decision provider 211 may initiate a warranty settlement process in step 521. If check decision provider 211 determines that a self-risk settlement service should be used to process this deposit, check decision provider 211 may initiate a self-risk settlement process in step 523. Upon initiating a settlement process in steps 512 or 523, check decision provider 211 may also send a message to image quality provider 209 indicating that the check is in the process of settlement.

FIG. 6 shows an exemplary check decision authorization process and optional manual review process, consistent with disclosed embodiments. Check decision authorization process 616 may represent a process for authorizing check deposit requests based on known data. Check decision authorization process 616 may be implemented as one or more computers, a software program, or a mixture of both. For example, check decision authorization process 616 can receive a check decision request containing a check image, information associated with the check (such as the amount, MICR data, payee/payor data, or the like), information on the consumer or mobile device which initiated the check deposit request, information on results from image quality provider 209, or the like. Check decision authorization process 616 may match that information against a set of known data in order to determine whether the check deposit request should be approved or not.

For example, check decision authorization process 616 can attempt to match received data against a knowledge file. Knowledge files, in some embodiments, may comprise full MICR data for approved checks. For example, a knowledge file may comprise at least one of a routing/transit number, an account number, or a check number, for each of a plurality of checks. Knowledge files may also contain information on the number or percentage of returned checks with particular MICR data. For example, in some embodiments, a knowledge file may include information on the percentage of checks returned that all contain the same routing/transit number and account number. (This could indicate, for example, an unreliable account.)

Check decision authorization process 616, in some embodiments, may also attempt to match received data against a cross-reference (abbreviated as “X-Reference”) file. A cross-reference file may contain information comprising merchants or other check-accepting institutions where a consumer has previously enrolled or deposited checks, along with information about that consumer (such as social security numbers). For example, if a consumer has previously deposited a check to a prepaid card at Store A, a cross-reference file may store information associating a consumer with Store A. Cross-reference files may also store information about the consumer's other enrollments, such as date, time, or usage history.

Check decision authorization process 616, in some embodiments, may also attempt to match information against risk modules. Risk modules, in some embodiments, may comprise fraud models with a number of attributes. The attributes may indicate situations in which fraud has been observed. Thus, a high degree of matches (for example, 75%) against those attributes may indicate a fraudulent transaction. When checking information against fraud models, check decision authorization process 616 may attempt to match the information received in the check deposit request with the attributes in one or more fraud models. If a high degree of matches are found between the information in the check deposit request and the fraud models, check decision authorization process 616 may indicate that the transaction should be declined. As another example, fraud models may be responsive to particular occurrences or external situations. For example, if a checkbook is stolen, check decision authorization process 616 may create a fraud model for stopping any checks from the account associated with the checkbook. Fraud models, in some embodiments, may also be equipped with overrides so that individuals who meet certain criteria will not be affected by the models.

Check decision authorization process 616 may also, in some embodiments, attempt to match information against positive pay files. Positive pay files, in some embodiments, contain information on checks that have been received and/or verified by a provider (such as image quality providers, processor platforms, payroll providers, tax refund preparers, merchants, or other check issuers). This information, in some embodiments, may include at least one of a routing number, an account number on the check, a check number, a check amount, or a portion of a social security number. In some embodiments, if check decision authorization process 616 finds information about a received check (e.g., part of the MICR data or other details about the check) in a knowledge file, check decision authorization process 616 may attempt to match the check against positive pay files. If check decision authorization process 616 determines a match, check decision authorization process may indicate that the transaction should be approved.

Check decision authorization process 616 may also, in some embodiments, attempt to match information against negative files. Negative files, in some embodiments, may contain information on checks that have been returned, checks that have bounced, checks that have been drawn on closed accounts, details of closed or suspended accounts, or the like. This information, in some embodiments, may include at least one of a routing number, an account number on the check, a check number, or a check amount. If check decision authorization process 616 determines a match, check decision authorization process may indicate that the transaction should be denied.

Check decision authorization process 616 may also attempt to match received information against other databases of identification information. For example, check decision authorization process 616 may attempt to match received information against a database of consumer information. In some embodiments, this database may include information usable for determining consumer identity, such as name, social security number, address, information on an identification document, or the like. If check decision authorization process 616 determines a match, check decision authorization process may indicate that the transaction should be approved.

In some embodiments, check decision authorization process 616 may determine whether the check deposit request should be approved, declined, or reviewed, based in part on the number of tests that failed. For example, check decision authorization process 616 may determine that a check deposit request should pass if all tests in process 616 passed, may determine that a check deposit request should fail if all tests in process 616 failed, and may determine that a check deposit request requires review if at least one test failed and at least one test passed. One of ordinary skill will recognize that other arrangements are possible (e.g., passing 75% of tests yields an approval, passing between 35% and 74.9% of tests yields a review, or the like).

As explained above with respect to, for example, FIGS. 5C and 5D, check decision provider 211 may determine that the check deposit request should be denied or approved, send messages to image quality provider 209 (as illustrated in step 648), and/or initiate settlement processes, as appropriate. However, if check decision provider 211 determines that the received check deposit request requires review, check decision provider 211 may proceed to step 622 and trigger a MIR request. For example, check decision provider 211 may initiate a manual image review request if a certain percentage of matches have been found between the check deposit request and the stored data.

Check decision provider 211 may initiate the request by sending information about the check deposit request to MIR application 634. The information may include, for example, information on the consumer that initiated the check deposit request, information on the check (e.g., MICR data or other information printed on the check), information about transaction(s) related to the check (e.g., whether the check is used to satisfy a debt), or the like.

MIR application 634 may receive an MIR request from check decision provider 211. In some embodiments, MIR application 634 may be implemented on the same computer as image quality provider 209, may be operated by the same entity that operates image quality provider 209, may be implemented on a separate computer from image quality provider 209, or the like.

Upon receiving the MIR request, risk analyst 638 may access the system in step 636 in order to review the manual image review request. In some embodiments, risk analyst 638 may receive an indication that a check deposit request requires review, may login to MIR application 634 (e.g., using a separate computer, implemented as described in FIG. 9), and manually review the check deposit request. In step 640, risk analyst 638 may send a disposition or decision on the manual image review to MIR application 634. For example, risk analyst 638 may send a message to MIR application 634 indicating reasons for declination of the check deposit request. For example, risk analyst 638 may determine that the check image is missing an endorsement, that the check image represents an ineligible check, that the MICR line on the check image cannot be read, that the check deposit request indicates a duplicate transaction, or the like Risk analyst 638 may then send this reason to MIR application 634, and MIR application 634 may then send a MIR response to check decision provider 211. In some embodiments, the disposition response may include at least one disposition reason code as indicated in step 642. Disposition reason codes, in some embodiments, correspond to a list of reasons for declining a check deposit request.

In step 644, check decision provider 211 may receive and log a MIR response from image quality provider 209, indicating the decision on the manual image review process and, in some embodiments, the reason for the disposition in the form of at least one disposition reason code. In step 646, a check decision provider 211 may make a final decision on the check deposit request. As explained above with respect to, for example, FIGS. 5C and 5D, based on the MIR response received in step 644, check decision provider 211 may determine that the check deposit request should be denied or approved, send messages to image quality provider 209 (as illustrated in step 648), and/or initiate settlement processes, as appropriate.

FIG. 7 shows an exemplary settlement flow diagram consistent with the disclosed embodiments. Each column (790, 792, 794, and 796) represents different time periods during which different entities perform processes to accomplish a settlement transaction, and each row represents the different entities. One of ordinary skill in the art will recognize that the particular time periods represented in the columns and the particular entities represented in the rows are merely exemplary. Additionally, one of ordinary skill will recognize that certain processes may be performed during time periods different from those in which they are illustrated.

The steps in column 790, in some embodiments, may be performed at the end of a business day. For example, column 790 represents processes that take place at 9:00 PM local time. In some embodiments, a settlement transaction may begin at step 718, as explained in FIGS. 5C and 5D, with the approval of a check deposit request.

In step 718, check decision provider 211 may determine that the check deposit request was approved, and may then determine the type of settlement service for depositing the check. As mentioned above, the particular service (e.g., warranty or self-risk) may be chosen by, for example, processor platform 207 or a mobile device.

As mentioned above, in some embodiments, warranty service means that check decision provider 211 may assume responsibility for the check by purchasing the check for its face value. So, if the check is later found to be fraudulent, bounces, or is otherwise uncollectable, check decision provider 211 could, in some embodiments, perform recovery processes to recover the amount of the check from the consumer that deposited the bad check.

As mentioned above, in some embodiments, self-risk service means that check decision provider does not assume responsibility for the check, So, if the check is later found to be fraudulent, bad, later bounces, or is otherwise uncollectable, processor platform 207 is responsible for recovery processes to recover the amount of the check from the consumer that deposited the bad check.

In some embodiments, if check decision provider 211 determines that a warranty settlement service should be used to process a check deposit request, check decision provider 211 may construct an “ACH file” in step 722. (“ACH” stands for Automated Clearing House, an electronic network for processing credit and debit transactions.)

Check decision provider 211 may then send the ACH file in step 724 to a bank 707A, which may receive and process the ACH file at step 726. In some embodiments, bank 707A may hold a deposit account associated with processing platform 207. Bank 707A, in some embodiments, is configured to accept ACH credits on behalf of processor platform 207.

During time period 796 (which in some embodiments occurs at least one day after the check deposit request was initiated), processor platform 207 may receive credit in its account. In some embodiments, this happens when bank 707A has accepted an ACH file on behalf of processor platform 207. This is represented by step 726. Once processor platform 207 receives the ACH credit in step 726, the transaction may be referred to as “settled” with respect to the processor platform 207.

Steps 722, 724, 726, and 728, in some embodiments, may be processed only if a warranty settlement service is used. In some embodiments, if check decision provider 211 determines that a self-risk settlement service should be used, check decision provider 211 may stop processing the check deposit request for the remainder of the first time period 790.

In some embodiments, regardless of the settlement service used by check decision provider 211 following step 718, image quality provider 209 may construct an image file representing the check image of an approved check deposit request in step 728 during time period 792 (e.g., during the day of the check deposit request and up until the beginning of a following business day). In some embodiments, this image file may include an image of the check, information on the check deposit request, information about the check itself, bank account information associated with check decision provider 211, or the like.

During time period 794 (e.g., during a business day after time period 792), check decision check decision provider 211 may receive the image file and store it in an image repository in step 730 and in a settlement database in step 732. In step 734, check decision provider 211 may generate reports relating to received and processed check deposit requests. In some embodiments, step 735 represents generation of reports corresponding to completed transactions. This enables any of the parties (e.g., banks 707A or 711A) to reconcile the money settled in accounts.

For example, reporting in step 735 may comprise generating and sending reports concerning past deposit requests. A report may contain, for example, a date that the report was generated, a date that a deposit request was settled or approved, information about checks involved in a deposit request, information about the account of the payee or payor of a check, information on a mobile device (e.g., mobile device 201) used to initiate the check deposit request, approval or declination messages, a deposit ID, an approval or settlement ID (indicating, for example, a unique approved deposit request), a reason code (e.g., a reason for declination), or the like.

A report may also contain unique or non-unique identifiers of parties involved in a deposit request, such as a mobile device (such as mobile device 201), a platform processor (such as platform processor 207), image quality provider 209, check decision provider 211, banks 707A or 711A, or the like.

Check decision provider 211 may determine which type of settlement service will be used to process the deposit request (e.g., warranty or self-risk). In some embodiments, if check decision provider 211 determines that a self-risk settlement service will be used in step 733, then in step 723, check decision provider 211 may construct and send an image cash letter (ICL) file to bank 707A containing account information of a consumer (such as a consumer using mobile device 201), because the consumer has not yet received payment for the check (due to the self-risk settlement service being used).

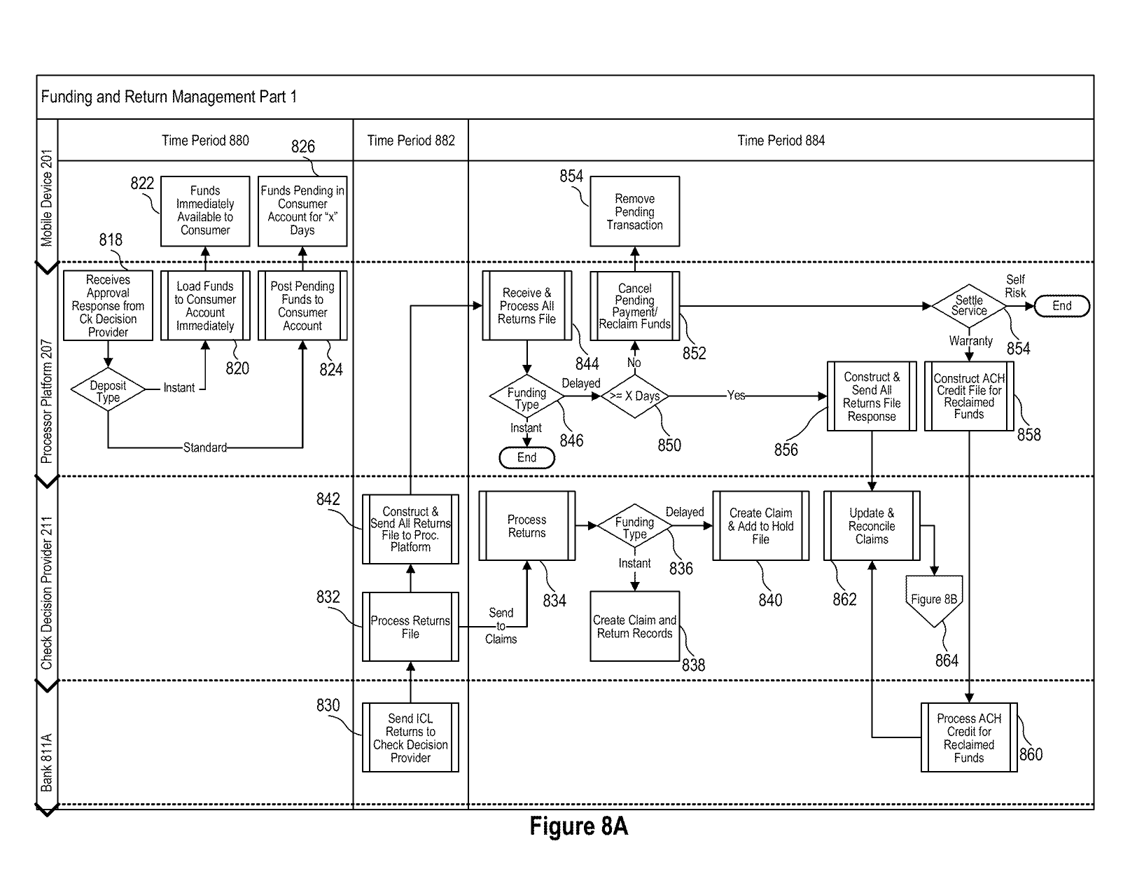

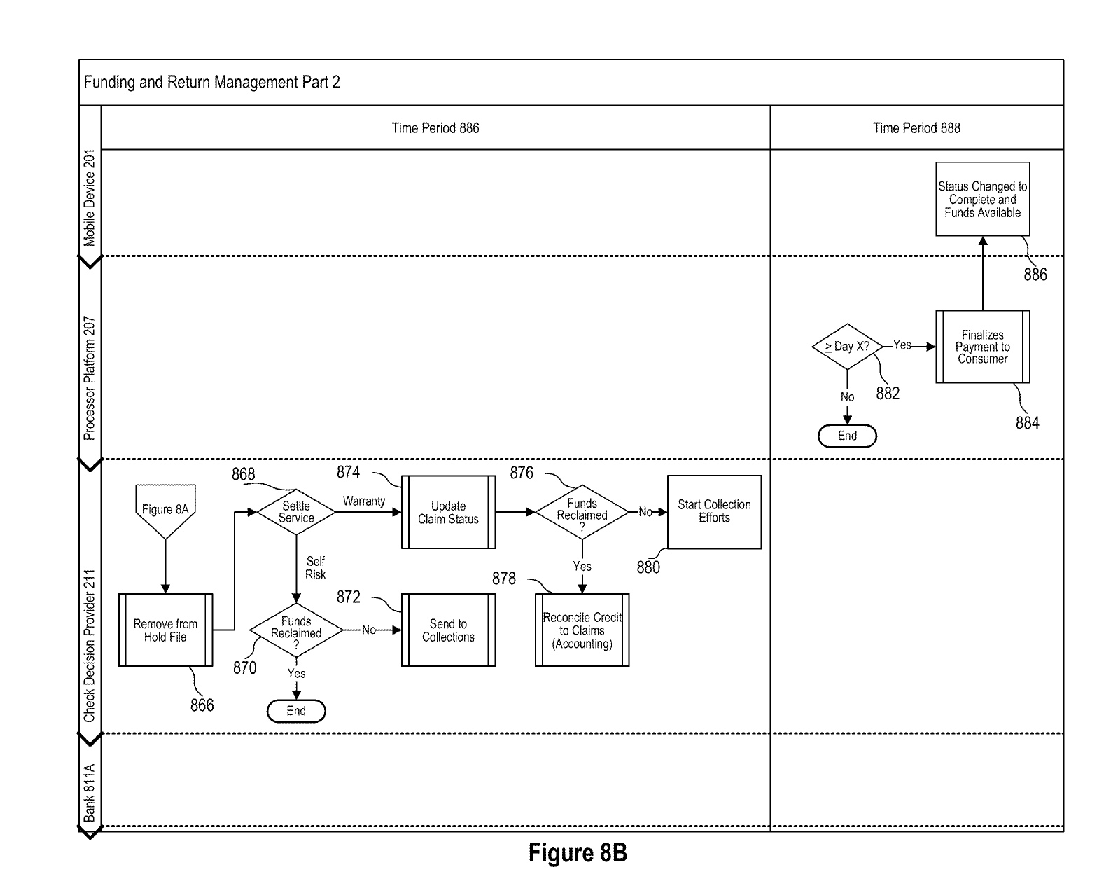

In step 725, Bank 707A may receive the ICL and process it for sending to the account associated with the consumer. During time period 796, the consumer may receive the ICL credit in his account. In some embodiments, the account of the consumer may receive the funds associated with the image cash letter after a settlement process has taken place (for example, as described below with respect to FIGS. 8A and 8B.

In some embodiments, if check decision provider 211 determines that a warranty settlement service will be used in step 733, then in step 736, check decision provider 211 may construct and send an image cash letter (ICL) file to bank 711A containing an account for check decision provider 211. Because the check is being settled using the warranty settlement service, check decision provider 211 has already “purchased” the check and assumed the risk. By receiving the image cash letter in its account, check decision provider 211 may (after it clears) receive funding for the check that it originally sent to payment processor 207 (and thus, to the associated consumer) in step 728.

In step 738, Bank 711A may receive the ICL and process it for sending to the account associated with check decision provider 211. During time period 796, check decision provider 211 may receive the ICL credit, indicating a deposit in the account of check decision provider 211.

FIGS. 8A and 8B show an exemplary funding and return management flow, consistent with the disclosed embodiments. Funding, in some embodiments, may represent a process by which a consumer's prepaid account, deposit account, or other account, is credited by the amount of the check the consumer is attempting to deposit. In one embodiment, funding comprises a process by which approved deposits are immediately deposited into the consumer's account and are available for use. (This has been referred to above as an “instant funding option.”) In another embodiment, funding comprises a process by which approved deposits are deposited into a consumer's account in a pending state, and are made available after a short time.

Return management, in some embodiments, refers to a process by which a check is returned after being deposited into a consumer's account. For example, if a check bounces after the consumer's account has been credited, return management processes enable the retrieval of the improperly credited amount. Processes involving return management, in some embodiments, operate differently depending on whether the funds have been deposited into a consumer's account or not.

The steps shown in FIGS. 8A and 8B may occur at the same time as, before, or after the steps in FIG. 7. During time period 880 of FIG. 8A processor platform 207 may receive an approval in step 818 from check decision provider 211, indicating that a check deposit request has been approved. Processor platform 207 may determine the funding option that will be used for this deposit. The received approval may contain an indication of the funding option; in some embodiments, mobile device 201 may prompt a consumer to select one of an instant or delayed funding option (as in step 442 of FIG. 4).

If processor platform 207 determines that the desired funding option is “instant,” processor platform 207 may load funds to the consumer's account immediately, as in step 820. In step 822, processor platform 207 may also, in some embodiments, send a message to mobile device 201 indicating that the funds are immediately available (as in step 552 of FIG. 5A).

If, however, processor platform 207 determines that the desired funding option is “delayed,” processor platform 207 may load funds to the consumer's account in a pending form in step 824. In some embodiments, pending funds are funds that may be part of a balance associated with the consumer's account but are not usable. So, if a consumer has $5.00 in available funds and deposits $25.00 using a delayed funding option and $12.00 using an instant funding option, the consumer's account will list $42.00 as a pending balance, but only $17.00 as an available balance. In some embodiments, consumers would be unable to use the money that is “pending” until some period of time has passed or a check associated with the pending funds has settled. Processor platform 207 may also, in some embodiments, send a message to mobile device 201 indicating that the funds have been deposited as pending, and will become available either after a period of time or after a check has been settled (as in step 556 of FIG. 5A).

During time period 882, bank 811A may send a return file to check decision provider 211 in step 830. The return file, in some embodiments, may contain a Deposit ID, a date that the deposit was returned, a MICR for the returned check, the check serial number, the amount of the check deposit, a return code corresponding to a reason for return, a date indicating the date of approval/declination of the check deposit, a settlement reference number, an Image Cash Letter containing the image of the check, or the like. In some embodiment, the return file contains information on a single returned check; however, in other embodiments, the return file may contain information on more than one returned check. In step 832, check decision provider 211 may receive the return file and process it along with other received return files.

In step 834, check decision provider 211 may begin processing the return file. In some embodiments, step 834 may occur during time period 884 (e.g., during a time period following receiving the return file). Check decision provider 211, upon beginning to process returns, may determine again what type of funding option was used to deposit the check. If check decision provider 211 determines that an instant funding option was used to process this deposit, check decision provider 211 may begin a process of attempting to recapture the funding deposited to the consumer's account in step 838. As mentioned above, in some embodiments, the instant funding option indicates that the consumer should receive the funding immediately after approval (as in step 820, during time period 880). Check decision provider 211 may create a claim against the account in an attempt to remove the funding. However, if check decision provider 211 determines in step 836 that a delayed funding option had been used, then in step 840, check decision provider may create a claim against the consumer's account and add the claim (including, for example, its associated Deposit ID) to a “hold” file. Hold files, in some embodiments, indicate deposit requests that should not be deposited or deposit requests for which funds should not be made available to the consumer because, for example, the check bounced.

In addition to processing received return files in step 832, check decision provider 211 may also construct and send an “All Returns” file to processor platform 207, in step 842. All Returns files, in some embodiments, contain information about check deposits that have been returned unpaid. For example, All Returns files may contain any of a Deposit ID, a date that the deposit was returned, a MICR for the returned check, the check serial number, the amount of the check deposit, a return code corresponding to a reason for return, a date indicating the date of approval/declination of the check deposit, a settlement reference number, or the like. Check decision provider 211 may send the All Returns file to processor platform 207 in step 842. In some embodiments, step 842 may be accomplished using FTP, HTTP, or any other data communication protocol.

In step 844, processor platform 207 may begin processing the All Return file. In some embodiments, step 844 may occur during time period 884. In step 846, processor platform 207 may determine what type of funding the check deposit originally used. If processor platform 207 determines that an instant funding option was used, then in step 848, processor platform 207 may end processing of the All Returns file with respect to this check deposit request. This is because the funding is already in the consumer's account. In some embodiments, processor platform 207 may then attempt to retrieve the funds from the consumer's account.

If, however, processor platform 207 determines that a delayed funding option was used to request the check deposit, processor platform 207 may then make a determination in step 850 as to whether a certain amount of time has passed since the initial deposit. In some embodiments, this amount of time corresponds to a delay associated with the delayed funding option. As mentioned above, a delayed funding option may provide funding to the account associated with the consumer after the passage of a period of time after the deposit is made. For example, a delayed funding option may not credit the consumer's account or make the funds “available” until 5 days have passed. During this time, the funding may appear in the consumer's account, but may appear as “pending” or “unavailable” funds.

If less than this period of time (e.g., 5 days) has passed, then the funds may still be pending in the consumer's account. In step 852, processor platform 207 may cancel the pending payment to the consumer's account and/or reclaim the funds from the consumer's account. In step 853, processor platform 207 may send a message to mobile device 201 indicating that the funds have been reversed. In some embodiments, this message may include a reason for the reversal.

Processor platform 207 may also, in step 854, determine which settlement service was used to accept the check deposit. If processor platform 207 determines that a self-risk settlement service was used, then processor platform 207 may end operations on this check deposit request. In some embodiments, a self-risk settlement service represents an ownership of the risk, and thus its corresponding loss of the bounced or fraudulent check, by processor platform 207. Processor platform 207 may then, in some embodiments, begin a recovery process (not pictured) to reclaim the funds. This may include debt collection services or the like.

If, however, processor platform 207 determines that a warranty settlement service was used, then processor platform 207 may proceed to step 858. Step 858 represents a process of constructing an ACH credit file for the reclaimed funds. In some embodiments, a warranty settlement service represents an ownership of the risk by check decision provider 211, and thus its corresponding loss of the bounced or fraudulent check, by check decision provider 211. The ACH credit file allows processor platform 207 to pay back check decision provider 211 for its warranty of the check because the funds have been (at least partially) recovered. In step 860, processor platform 207 may send the ACH credit file to bank 811A. Bank 811A may then deposit the received funds into an account owned by check decision provider 211.

Referring back to step 850, if more than a specified period of time (e.g. 5 days) has passed, then the funds in the consumer's account may have been converted from pending to available. Thus, in some embodiments, processor platform 207 may not be able to reclaim the funds merely by reversing the deposit or retrieving the funds. For instance, the consumer may have already spent the money corresponding to the check because it was made available.

In step 856, processor platform 207 may construct a response to the All Returns file. In some embodiments, the response may contain some of the same data fields as in the All Returns file received in step 842 (for example, a Deposit ID, a date that the deposit was returned, a MICR for the returned check, the check serial number, the amount of the check deposit, a return code corresponding to a reason for return, a date indicating the date of approval/declination of the check deposit, or a settlement reference number). In some embodiments, step 856 may be accomplished using FTP, HTTP, or any other data communication protocol.

The response in step 856 may also contain information on recovery disposition. A recovery disposition may be listed for each check deposit request in the response. In some embodiments, recovery disposition may be listed in the form of a single letter or character, and may indicate the outcome of attempting to retrieve funds from a consumer's account. For example, an “S” in the response may indicate that processor platform 207 was able to recover funds from the account, and that processor platform 207 may send the funds to an account associated with check decision provider 211. A “U” in the response may indicate that processor platform 207 was unable to recover funds (for example, because they had already been spent by the consumer). “U” may also indicate that check decision provider 211 should pursue recovery or debt collection options. An “R” in the response may indicate that processor platform 207 was able to recover funds, and that check decision provider 211 may send an invoice to processor platform to recover the funds. One of ordinary skill will recognize that other messages may be received as part of this response, and that the response may indicate the outcome of one or more checks.

The response may also contain an indication of the status of the consumer's account. Check decision provider 211 may utilize this information for deciding on future check deposit requests by, for example, storing this information in a database (such as those mentioned in check decision authorization provider 616 in FIG. 6). The response may contain an indication that the account is closed, locked (e.g., temporarily inaccessible to the consumer), open, permanently closed, or the like.

The response may also contain information on the date that funds were retrieved from the consumer's account or the amount of funds that were retrieved. For example, if some funds were still unavailable to the consumer when processor platform 207 received the All Returns file in step 844, processor platform 207 may have been able to reclaim some funds from the consumer's account. The response may indicate how many funds were recovered and on what date the recovery took place. In step 864, processor platform 207 may send this response to check decision provider 211.

In step 862, check decision provider may receive the response from processor platform 207 in step 864 or an indication of the ACH credit from bank 811A in step 860. In step 864, check decision provider may proceed to a second phase of funding and return management in FIG. 8B. FIG. 8B may represent steps that, in some embodiments, would occur only for a check deposit request deposited using the delayed funding service.

FIG. 8B may begin during time period 886 with check decision provider 211 removing the return from a hold file in step 866. For example, as in step 840 of FIG. 8A, a claim against the consumer's account may be added to a hold file, in order to prevent the consumer from using at least some of the money associated with the bad check. Hold files, in some embodiments, may identify received information on returned checks. Claims may be removed from the hold file if, for example, check decision provider 211 has received a final decision on whether the funds were recovered (for example, if the funds were not recovered as in step 856, or were recovered as in step 852).

In step 868, check decision provider 211 may determine which settlement service was used for the original check deposit request (e.g., the above-mentioned self-risk or warranty settlement services). In some embodiments, if check decision provider 211 determines that self-risk settlement was used, check decision provider 211 may then determine whether the funds were reclaimed in step 870. (For example, funds may already have been reclaimed from the consumer's account in step 852 of FIG. 8A.) If so, check decision provider 211 may cease operating on this check deposit. (Because the funds were reclaimed, no further action may be necessary on this check deposit.)

However, if check decision provider 211 determines that the funds were not reclaimed, check decision provider 211 may send a collection request to a collection provider. For example, check decision provider 211 may send instructions to a collections agency to attempt to collect the funds from the consumer.

If, however, in step 868, check decision provider 211 determines that a warranty settlement service was used to deposit the check, check decision provider 211 may update a status of the claim against the consumer's account in step 874. In some embodiments, check decision provider 211 may update the claim with a response from processor platform 207 (for example, the response relating to attempts to recover the payment, received in step 862 of FIG. 8A). In step 876, check decision provider 211 may determine whether the funds were reclaimed (for example, by processing the response received in step 862 of FIG. 8A). If the funds were reclaimed, check decision provider 211 may begin a reconciliation process in step 878. In some embodiments, the process in step 878 may include reconciling stored claims to indicate that the associated deposit has been retrieved.

If, however, check decision provider 211 determines that the funds were not reclaimed, check decision provider 211 may begin collection processes in step 880. For example, check decision provider 211 may send instructions to a collections agency to attempt to collect the funds from the consumer.

Time period 888 may represent a period of time after a delayed deposit request has been made, after which funds may be made available to consumers. As mentioned above, a delayed funding option may provide funding to the account associated with the consumer after the passage of a period of time after the deposit is made. For example, a delayed funding option may not actually credit the consumer's account until 5 days have passed. During this time, the funding may appear in the consumer's account, but may appear as “pending” or “unavailable” funds.

Assuming that a check deposit request has not failed for some reason, processor platform 888 may determine in step 882 whether the period of time associated with the delayed funding option has passed. If less than this period of time (e.g., 5 days) has passed, the process may end. However, if the period of time has passed, processor platform 207 may proceed to step 884 to finalize the payment to the consumer. For example, step 884 may include making the funds associated with a check deposit available or generating a message for sending to mobile device 201. In step 886, processor platform 207 may send a message to mobile device 201 indicating that the deposit is now available for use by the consumer.

FIG. 9 shows an exemplary computing device 900, consistent with disclosed embodiments. Variations of computer device 900 may be used for implementing mobile devices (such as mobile device 201), processor platform 207, image quality provider 209, check decision provider 211, or database 213.

As shown in FIG. 9, exemplary computer device 900 may include one or more central processing units 901 for managing and processing data and operations consistent with the disclosed embodiments. CPU 901 may be configured to process data, execute software instructions stored in memory, and transmit data between the other components of device 900. For example, CPU 901 may be implemented as a mobile microprocessor, a desktop microprocessor, a server microprocessor, or any other type of processor, as one of ordinary skill will understand.

In some embodiments, computer device 900 may also include one or more input devices 902, which are configured to receive input from a consumer, other computers, other devices, or other modules. Input devices 902 may include, but are not limited to, keyboards, mice, trackballs, trackpads, scanners, cameras, external storage or information devices, touchscreens, keypads, or other devices, which connect via Universal Serial Bus (USB), serial, parallel, infrared, wireless, wired, or other connections.

Computer device 900 may also include one or more storage devices 903. Storage devices 903 may be comprise optical, magnetic, flash, signal, or any other type of memory configured to store information. Storage devices 903 may store, for example, data, instructions, programs/applications, operating systems, or a combination of these.

Computer device 900 also includes one or more output devices 904 that may be configured to transmit data to consumers and/or modules or devices. Such modules or devices may include, but are not limited to, computer monitors, televisions, screens, displays, interface ports, projectors, printers, plotters, and other recording/displaying devices which connect via wired or wireless connections.

Computer device 900 may also include one or more network devices 905. Network device 905 may be configured to allow computer device 900 to connect to and exchange information with networks (e.g., network 205), such as the Internet, a local area network, a wide area network, a cellular network, a wireless network, a satellite network, or any other type or combination of network(s). Network device 905 may be implemented as a wired network adapter, a wireless network adapter, an infrared network adapter, a cellular or satellite network adapter, or any other type of network adapter.

Computer device 900 may also include one or more power units 906, which may enable computer device 700 and its components to receive power and operate. Power units 906, in some embodiments, may be implemented as a power supply, a battery, or the like.

While FIG. 9 illustrates the components in FIG. 9 as connected to CPU 901, other connections and configurations are possible, such as a “bus” or other connective links. Additionally, while the devices in FIG. 9 are represented in a singular form, in some embodiments, more than one of each of the devices in FIG. 9 may be implemented.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Other implementations are also within the scope of the present disclosure.

Additionally, while certain modules and devices are illustrated as implemented as separate computers, in some embodiments, these modules and devices may be implemented as software code or programs operating on computers, computer processors, devices, or the like.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate one or more embodiments and together with the description, serve to explain certain aspects of the disclosed embodiments.

What is claimed is:

1. A method of processing a check image for deposit, comprising:
receiving, from a mobile device associated with an account holder, a deposit request for a check, the deposit request comprising an account identifier and a check image;
performing an image quality analysis using the check image;
performing, with at least one computer associated with a check decision provider, a check decision authorization process, using the account identifier, and at least one identity data source; and
determining whether the deposit request exceeds at least one limit; and
if not, determining whether the image quality analysis and check decision authorization process were successful, and
if so, determining whether the account issuer uses warranty processing or self-risk processing:
if the account issuer uses warranty processing, creating and sending an image file associated with the check to a bank associated with the check decision provider, and sending an approval response to a bank associated with the account issuer; and
if the account issuer uses self-risk processing, creating and sending an image file associated with the check to a bank associated with the account issuer.

2. The method of claim 1, wherein the image file comprises an Image Cash Letter.

3. The method of claim 1, wherein the approval response comprises an ACH origination message.

4. The method of claim 1, wherein the method further comprises:
if the check decision authorization process was not successful, sending one of a hard decline or a soft decline.

5. The method of claim 4, wherein the received deposit request further comprises an indication of one of a delayed or instant funding option; and wherein the method further comprises:
sending a soft decline;
determining whether the received deposit request comprises an indication of an instant funding option or a delayed funding option;
if the deposit request comprises an indication of an instant funding option, receiving a second deposit request from the mobile device comprising an indication of a delayed funding option.

6. The method of claim 4, wherein the deposit request further comprises an indication of one of a delayed or instant funding option; and wherein the method further comprises:
if the deposit request comprises an indication of a delayed funding option:
sending a returns message to the bank associated with the account issuer, indicating that the check was returned unpaid; and
receiving a returns message indicating that an amount associated with the unpaid check was one of recovered or not recovered.

7. The method of claim 6, wherein if the received returns message indicates that the amount was not recovered, initiating a collection process to recover the amount.

8. The method of claim 1, wherein the check image comprises representations of a front side of the check, a MICR line, and a back side of the check.

9. The method of claim 8, wherein the step of performing an image quality analysis comprises at least one of:
determining whether the check image meets a focus threshold;
determining whether the MICR line is legible; or
determining whether an endorsement is visible on the representation of the back side of the check.

10. The method of claim 1, wherein the at least one limit comprises at least one of:
a limit on the number of deposits during a first time period, or
a limit on the value of deposits during a second time period.

11. A method for processing a check image for deposit, using at least one computer associated with an account issuer, comprising:
receiving a deposit request for a check, from a mobile device associated with a consumer, the deposit request comprising an account identifier and a check image;
determining whether the deposit request exceeds at least one limit;
based on the determining step, sending the deposit request to a computer associated with a check decision provider; and
receiving a response from the computer associated with the check decision provider,
wherein if the response comprises a denial, sending a message to the mobile device indicating that the deposit request associated with the check image can be attempted again.

12. The method of claim 11, wherein the received deposit request further comprises an indication of one of a delayed or instant funding option; and wherein the method further comprises:
determining whether the received deposit request comprises an indication of a delayed funding option, and
if so, initiating a fund load process with an account associated with the consumer; and
if not, initiating a pending funds load with the account associated with the consumer.

13. The method of claim 12, wherein the denial further comprises one of a hard denial or a soft denial.

14. The method of claim 13, wherein the denial comprises a soft denial and the received deposit request comprises an indication of an instant funding option; and
wherein the message sent to the mobile device comprises an indication that the deposit request associated with the check can be attempted again using a delayed funding option.

15. The method of claim 11, wherein the at least one limit comprises at least one of:
a limit on the number of deposits during a first time period, or
a limit on the value of deposits during a second time period.

16. A system for processing a check image for deposit, comprising:
at least one processor, and
a memory containing instructions that, when executed by the at least one processor, cause the at least one processor to perform a method comprising:
receiving, from a mobile device associated with an account holder, a deposit request for a check, the deposit request comprising an account identifier and a check image; and
performing an image quality analysis, using the check image;
performing, a check decision authorization process, using the account identifier and at least one identity data source;
determining whether the deposit request exceeds at least one limit; and
if not, determining whether the image quality analysis and check decision authorization process were successful, and
if so, determining whether an account issuer associated with the account identifier uses warranty processing or self-risk processing:
if the account issuer uses warranty processing, creating and sending an image file associated with the check to a bank associated with the check decision provider, and sending an approval response to a bank associated with the account issuer; and
if the account issuer uses self-risk processing, creating and sending an image file associated with the check to a bank associated with the account issuer.

17. The system of claim 16, wherein the image file comprises an Image Cash Letter.

18. The system of claim 16, wherein the approval response comprises an ACH origination message.

19. The system of claim 16, wherein the method performed by the at least one processor further comprises:
if the check decision authorization process was not successful, sending one of a hard decline or a soft decline.

20. The system of claim 19, wherein the deposit request further comprises an indication of one of a delayed or instant funding option; and wherein the method performed by the at least one processor further comprises:
sending a soft decline;
determining whether the deposit request comprises an indication of an instant funding option or a delayed funding option;
if the deposit request comprises an indication of an instant funding option, receiving a second deposit request from the mobile device comprising an indication of a delayed funding option.

21. The system of claim 19, wherein the received deposit request further comprises an indication of one of a delayed or instant funding option; and wherein the method performed by the at least one processor further comprises:
if the received deposit request comprises an indication of a delayed funding option:
sending a returns message to the bank associated with the account issuer, indicating that the check was returned unpaid; and
receiving a returns message indicating that an amount associated with the unpaid check was recovered or was not unrecovered.

22. The system of claim 21, wherein the method performed by the at least one processor further comprises:
if the received returns message indicates that the amount was not recovered, initiating a collection process to recover the amount.

23. The system of claim 16, wherein the check image comprises representations of a front side of the check, a MICR line, and a back side of the check.

24. The system of claim 23, wherein the step of performing an image quality analysis comprises at least one of:
determining whether the check image meets a focus threshold;
determining whether the MICR line is legible; or
determining whether an endorsement is visible on the representation of the back side of the check.

25. The system of claim 16, wherein the at least one limit comprises at least one of:
a limit on the number of deposits during a first time period, or
a limit on the value of deposits during a second time period.

26. A system for processing a check image for deposit comprising:
at least one processor; and
a memory containing instructions that, when executed by the at least one processor, cause the at least one processor to perform a method comprising:
receiving a deposit request for a check, from a mobile device associated with a consumer, the deposit request comprising an account identifier and a check image;
determining whether the deposit request exceeds at least one limit;
based on the determining step, sending the deposit request to a computer associated with a check decision provider; and
receiving a response from the computer associated with the check decision provider,
wherein if the response comprises a denial, sending a message to the mobile device indicating that the deposit request associated with the check image can be attempted again.

27. The system of claim 26, wherein the received deposit request further comprises an indication of one of a delayed or instant funding option; and
wherein the method performed by the at least one processor further comprises:
determining whether the received deposit request comprises an indication of a delayed funding option, and
if so, initiating a fund load process with an account associated with the consumer; and
if not, initiating a pending funds load with the account associated with the consumer.

28. The system of claim 27, wherein the denial further comprises one of a hard denial or a soft denial.

29. The system of claim 28, wherein the denial comprises a soft denial and the received deposit request comprises an indication of an instant funding option; and
wherein the message sent to the mobile device comprises an indication that the deposit request associated with the check can be attempted again using a delayed funding option.

30. The system of claim 26, wherein the at least one limit comprises at least one of:
a limit on the number of deposits during a first time period, or
a limit on the value of deposits during a second time period.
